(19) United States
(12) Patent Application Publication
(10) Pub. No.: US 2026/0075545 A1
(43) Pub. Date: Mar. 12, 2026

(54) AUTONOMOUS POWER HEADROOM REPORTING

(71) Applicant: QUALCOMM Incorporated, San Diego, CA (US)

(72) Inventors: Sitaramanjaneyulu KANAMARLAPUDI, San Diego, CA (US); Qing LI, Princeton Junction, NJ (US); Linhai HE, San Diego, CA (US); Hyun Yong LEE, San Diego, CA (US); Gavin Bernard HORN, La Jolla, CA (US)

(21) Appl. No.: 18/883,628

(22) Filed: Sep. 12, 2024

(51) Int. Cl. H04W 52/36; H04W 52/40

(52) U.S. Cl. CPC H04W 52/365; H04W 52/40

(57) ABSTRACT

Various aspects of the present disclosure generally relate to wireless communication. In some aspects, a user equipment (UE) may receive, from a network node, a message indicating that one or more power headroom report (PHR) parameters. The UE may select a value for the one or more PHR parameters in accordance with the message. The UE may transmit a PHR in accordance with the one or more PHR parameters. Numerous other aspects are described.

### FIELD OF THE DISCLOSURE

Aspects of the present disclosure generally relate to wireless communication and specifically relate to techniques, apparatuses, and methods for autonomous power headroom reporting.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes receiving, from a network node, a message indicating that one or more power headroom report (PHR) parameters are flexible for the UE; selecting a value for the one or more PHR parameters in accordance with the message; and transmitting a PHR in accordance with the one or more PHR parameters.

In some aspects, a method of wireless communication performed by a network node includes transmitting, to a UE, a message indicating that one or more PHR parameters are flexible for the UE; receiving a PHR in accordance with the one or more PHR parameters; and communicating in accordance with the PHR.

In some aspects, an apparatus for wireless communication at a UE includes one or more memories; and one or more processors, coupled to the one or more memories, configured to cause the UE to: receive, from a network node, a message indicating that one or more PHR parameters are flexible for the UE; select a value for the one or more PHR parameters in accordance with the message; and transmit a PHR in accordance with the one or more PHR parameters.

In some aspects, an apparatus for wireless communication at a network node includes one or more memories; and one or more processors, coupled to the one or more memories, configured to cause the network node to: transmit, to a UE, a message indicating that one or more PHR parameters are flexible for the UE; receive a PHR in accordance with the one or more PHR parameters; and communicate in accordance with the PHR.

In some aspects, a non-transitory computer-readable medium storing a set of instructions for wireless communication includes one or more instructions that, when executed by one or more processors of a UE, cause the UE to: receive, from a network node, a message indicating that one or more PHR parameters are flexible for the UE; select a value for the one or more PHR parameters in accordance with the message; and transmit a PHR in accordance with the one or more PHR parameters.

In some aspects, a non-transitory computer-readable medium storing a set of instructions for wireless communication includes one or more instructions that, when executed by one or more processors of a network node, cause the network node to: transmit, to a UE, a message indicating that one or more PHR parameters are flexible for the UE; receive a PHR in accordance with the one or more PHR parameters; and communicate in accordance with the PHR.

In some aspects, an apparatus for wireless communication includes means for receiving, from a network node, a message indicating that one or more PHR parameters are flexible for the UE; means for selecting a value for the one or more PHR parameters in accordance with the message; and means for transmitting a PHR in accordance with the one or more PHR parameters.

In some aspects, an apparatus for wireless communication includes means for transmitting, to a UE, a message indicating that one or more PHR parameters are flexible for the UE; means for receiving a PHR in accordance with the one or more PHR parameters; and means for communicating in accordance with the PHR.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of power headroom report (PHR) reporting, in accordance with the present disclosure.

FIG. 5 is a diagram illustrating an example of conditions and timers associated with PHR transmission, in accordance with the present disclosure.

FIG. 6 is a diagram illustrating an example of autonomous PHR reporting, in accordance with the present disclosure.

FIG. 7 is a diagram illustrating an example associated with artificial intelligence/machine learning (AI/ML)-based PHR reporting, in accordance with the present disclosure.

FIG. 8 is a diagram illustrating an example architecture of a functional framework for radio access network (RAN) intelligence enabled by data collection, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communications systems may support variable uplink traffic patterns between a user equipment (UE) and a network node based on an amount of power available to the UE for uplink transmissions. The available amount of power may be referred to as power headroom, which may indicate how much transmission power is available for the UE to use in addition to an amount of power being used for a current (e.g., pre-existing or scheduled) transmission. In some examples, the UE may transmit a power headroom report (PHR) to the network node, that indicates a current UE transmission power (e.g., an estimated transmission power) and a remaining amount of transmission power (e.g., the PHR may be included in a control message). The network node may use the PHR to report value to estimate how much uplink bandwidth the UE may use for a given duration. As the UE communicates during more time/frequency resources, the higher the UE transmission power becomes, but the UE transmission power may not exceed a maximum power (e.g., a permissible power). PHR reporting may provide a framework for the efficient use of excess available transmission power at a UE.

PHR reporting may configured by the network node through timers, events, and/or types of reporting for various cell-based configurations, among other examples, to aid in optimizing uplink resource scheduling (e.g., from the network node perspective). PHR reporting may additionally help to ensure that power limits (e.g., maximum permissible energy (MPE) limits) are satisfied for communications in some frequency bands (e.g., in case of FR2 operation or band-specific operations). In some examples, the communication of PHR reports may provide support for power-aware packet scheduling and may help the UE with regulatory requirements to satisfy power limit thresholds in some frequency bands (e.g., to satisfy MPE limits in FR2). In some examples, a single PHR reporting parameter configuration (e.g., PHR-Config) may be enabled per UE.

Some wireless communication systems (e.g., such as 6G communication systems) may support a diversified set of traffic characteristics, which may include conditions such as dynamic quality of service (QoS) requirements, dynamic packet burst patterns, and/or different transmit power control requirements than some preceding wireless communication systems (e.g., 5G communication systems and/or 4G communication systems), among other examples. As a result, a single PHR reporting parameter configuration (e.g., PHR-Config) may result in degraded performance due to the varying conditions and traffic requirements that exist in such wireless communications systems. For example, a static, singular PHR reporting parameter configuration may result in inefficient reporting or may inadvertently skip opportunities in which transmitting a PHR may increase spectral efficiency, because, for example, as traffic characteristics change frequently, the singular PHR reporting parameter configuration may not be configured or designed for different traffic characteristics or requirements, resulting in inefficient, inaccurate, and/or irrelevant PHR reporting by the UE.

Aspects of the present disclosure generally relate to autonomous PHR reporting. Some aspects more specifically relate to a UE autonomously transmitting a PHR based on an adjustable PHR reporting configuration. Transmission of the PHR and/or the adjustable PHR reporting configuration may be supported or informed by an artificial intelligence and/or machine learning (AI/ML) model. As used herein, “autonomously” may refer to a decision-making process (e.g., decision-making mechanism or configuration) at an entity in which the decision is independent of permissions or triggers such as signaling from another entity, or may refer to a decision-making process that overrides an initiative from another entity. That is, the UE may determine to transmit a PHR based on an autonomous PHR reporting configuration being enabled at the UE, and further based on one or more communication parameters known to the UE, without waiting for explicit instructions or a trigger. For example, a UE may receive, from a network node, a message indicating that one or more PHR parameters are flexible for the UE. As used herein, “flexible for the UE” refers to a state in which the parameter has flexible values, configurations, or settings. For example, when a parameter is flexible for the UE, the UE may modify (e.g., autonomously) the value, configuration, or setting of the parameter based on, or otherwise associated with, one or more factors, as described in more detail elsewhere herein.

The flexibility of one or more parameters may enable or support autonomous PHR reporting by the UE in which parameters (e.g., one or more PHR parameters) that may trigger such an autonomous report may be input to an AI/ML model, which may use the parameters to help inform PHR reporting by the UE. Some aspects described herein provide for the network node to transmit a configuration that indicates which parameters relating to PHR reporting are flexible for the UE in which values of these parameters can be selected by the UE. The UE may select a value for the one or more PHR parameters in accordance with the message. As used herein, the UE “selecting a value” for a PHR parameter may refer to the UE determining, obtaining an indication of, deriving, calculating, identifying, among other examples, the value for the PHR parameter. In some aspects, the value for the PHR parameter may be a numerical value, a setting, a type or configuration (e.g., a report type, or a quantity of report), a timer (e.g., a value of a timer), a mode (e.g., a reporting mode), a trigger value, and/or a threshold value, among other examples, for the PHR parameter. The UE may transmit a PHR in accordance with the one or more PHR parameters. For example, the UE may determine to transmit the PHR based on one of the one or more PHR parameters satisfying a condition for triggering a PHR by the UE in accordance with a flexible PHR reporting parameter configuration.

As a result, a more flexible PHR reporting parameter configuration may support enhanced communications between the UE and the network node. “Flexible” may be used herein interchangeably with “adjustable,” and when used in conjunction with “parameter” may signify that a parameter (e.g., a value, a setting, and/or a condition for a parameter) may be changed or adjusted based on one or more parameters associated with uplink communications at the UE or based on an AI/ML model, or may be used to train an AI/ML model.

A framework for PHR reporting in which a UE may autonomously use various key performance indicators and tools such as periodic/prohibit timers, report types, pathloss threshold(s), MPE specific or band specific parameters, or the like, based on knowledge of radio conditions experienced by the UE and in some examples further informed by an AI/ML model for more flexible and efficient uplink resource scheduling, may increase spectral efficiency and reliability, and may decrease latency.

Particular aspects of the subject matter described in this disclosure can be implemented to realize one or more of the following potential advantages. In some aspects, by a UE receiving a message indicating that the one or more PHR parameters are flexible for the UE, the described techniques can be used to increase PHR reporting flexibility at the UE, thereby reporting and potentially taking advantage of available transmission power that may otherwise be overlooked and under-utilized in an inflexible PHR reporting configuration. In some aspects, by selecting a value for the one or more PHR parameters in accordance with the message, the described techniques can be used to increase efficiency of uplink scheduling pattern because the UE may autonomously choose different values, ranges, or conditions for the PHR parameters. For example, a flexible range of PHR timers may support opportunities for the UE to transmit PHR reports based on various factors determined or experienced by the UE, such as criticality of a communication, a variation in power, or the like. In some aspects, by transmitting a PHR in accordance with the one or more PHR parameters, the UE may support efficient scheduling of uplink resources by autonomously alerting the network node to available transmission space, thereby potentially increasing throughput.

In some examples, the UE may select (e.g., determine or obtain an indication of) one or more values for the one or more PHR parameters that are flexible for the UE using an AI/ML model. In some examples, the UE may receive information indicating the AI/ML model. In some examples, the UE may train the training the AI/ML model using at least one PHR key performance indicator (KPI) or may transmit an indication of at least one PHR KPI to the network node.

In some aspects, by selecting one or more values for the one or more PHR parameters using the AI/ML model, the described techniques can enable a UE to autonomously determine and influence the PHR timers, triggering conditions, frequency band/MPE-specific configurations based on radio conditions, a current uplink grant pattern, an uplink traffic pattern and internal dynamic information about the thermal or smart transmission power adjustment between carriers. Additionally, increased PHR performance may help the network node to enable dual connectivity, or a secondary cell and an associated grant pattern. In some aspects, by the UE receiving information indicating the AI/ML model, the described techniques can be used to ensure reliability between the network node and the UE and may support AI/ML-based PHR performance as well as interference and measurement reports. In some aspects, by training the AI/ML model using at least one PHR KPI, the described techniques can be used to increase efficiency of PHR reporting thereby taking advantage of opportunities or anticipating opportunities for transmitting a PHR. In some aspects, by transmitting an indication of at least one PHR KPI to the network node, the described techniques can be used to support more efficient scheduling of uplink resources by the network node. In some examples, by training the AI/ML model locally and transmitting information to the network node such that the network node may train the network-local AI/ML model, the UE may autonomously find different values for enabling (e.g., selecting or determining) a more efficient uplink scheduling pattern available from the network node.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

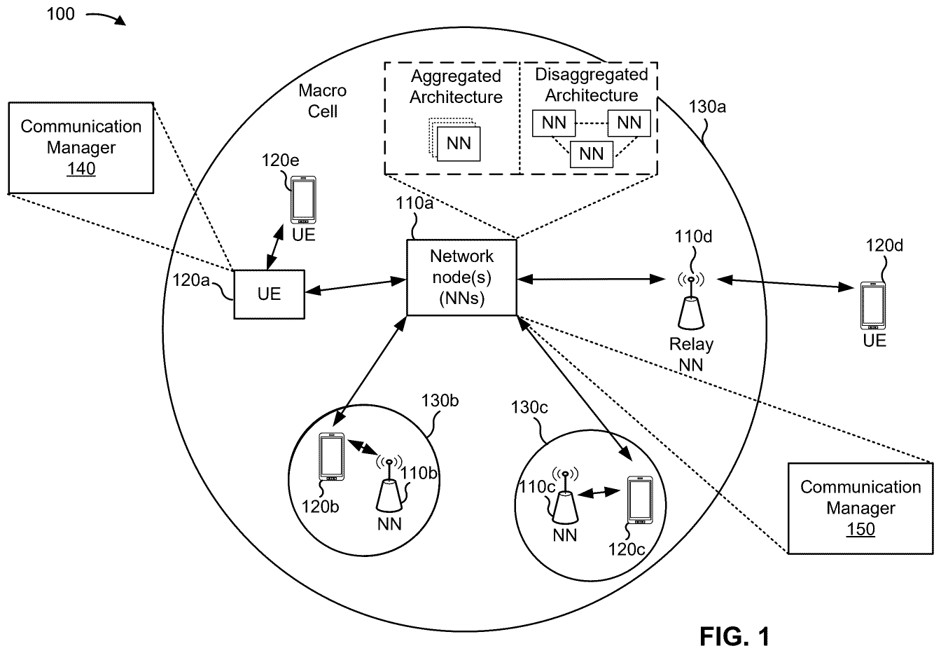

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a network node, a message indicating that one or more PHR parameters are flexible for the UE; select a value for the one or more PHR parameters in accordance with the message; and transmit a PHR in accordance with the one or more PHR parameters. Additionally, or alternatively, the communication manager 140 may perform one or more other operations described herein.

In some aspects, the network node 110 may include a communication manager 150. As described in more detail elsewhere herein, the communication manager 150 may transmit, to a UE, a message indicating that one or more PHR parameters are flexible for the UE; receive a PHR in accordance with the one or more PHR parameters; and communicate in accordance with the PHR. Additionally, or alternatively, the communication manager 150 may perform one or more other operations described herein.

As indicated above, FIG. 1 is provided as an example. Other examples may differ from what is described with regard to FIG. 1.

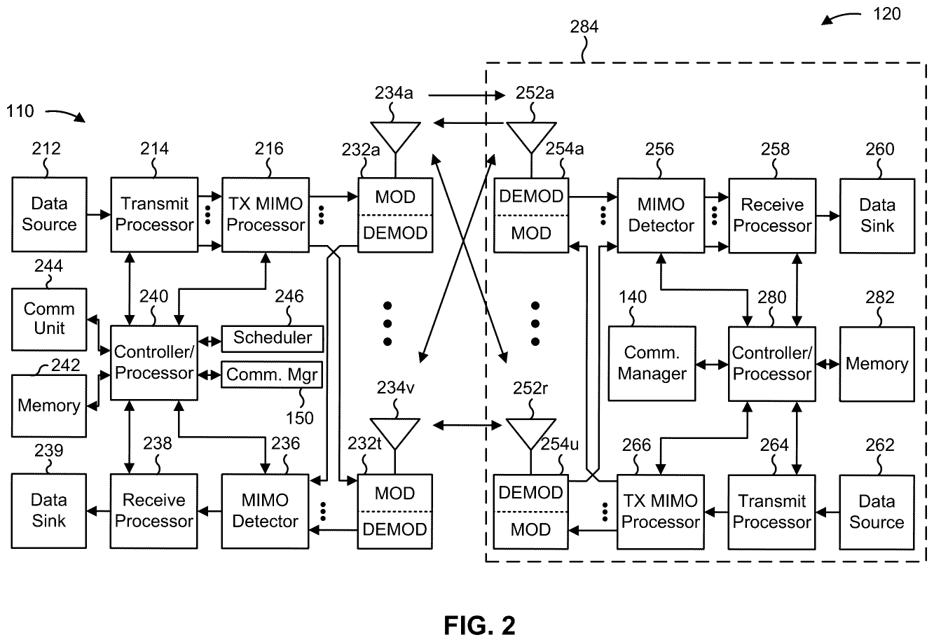

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

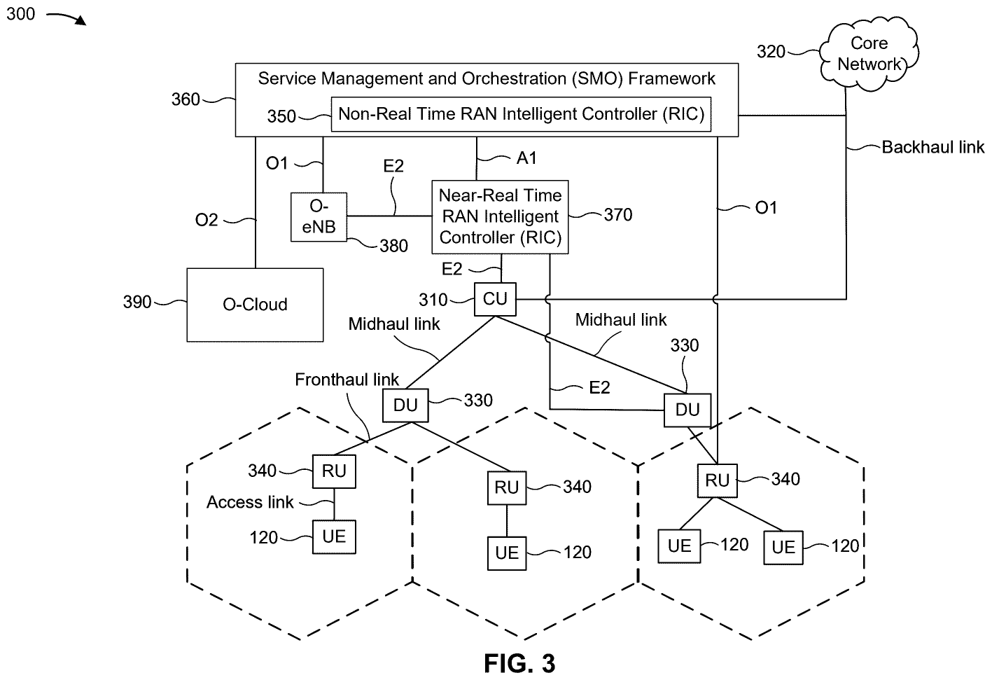

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

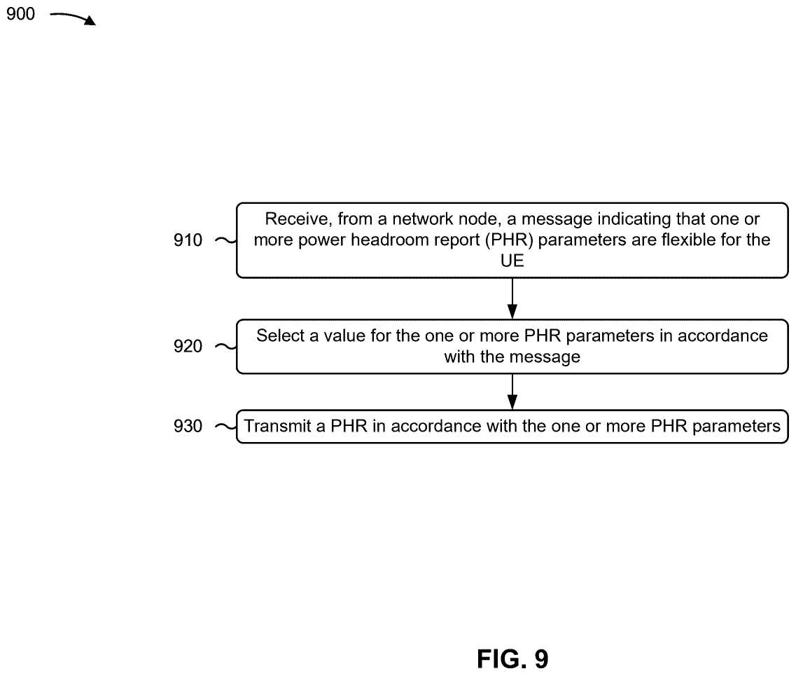

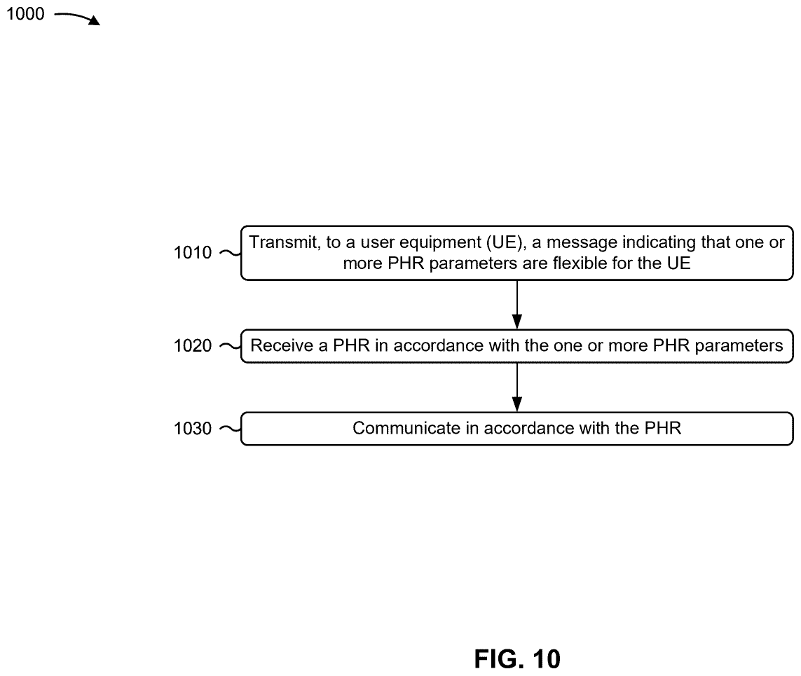

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with autonomous PHR reporting, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving, from a network node 110, a message indicating that one or more PHR parameters are flexible for the UE; means for selecting a value for the one or more PHR parameters in accordance with the message; and/or means for transmitting a PHR in accordance with the one or more PHR parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120, a message indicating that one or more PHR parameters are flexible for the UE; means for receiving a PHR in accordance with the one or more PHR parameters; and/or means for communicating in accordance with the PHR. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

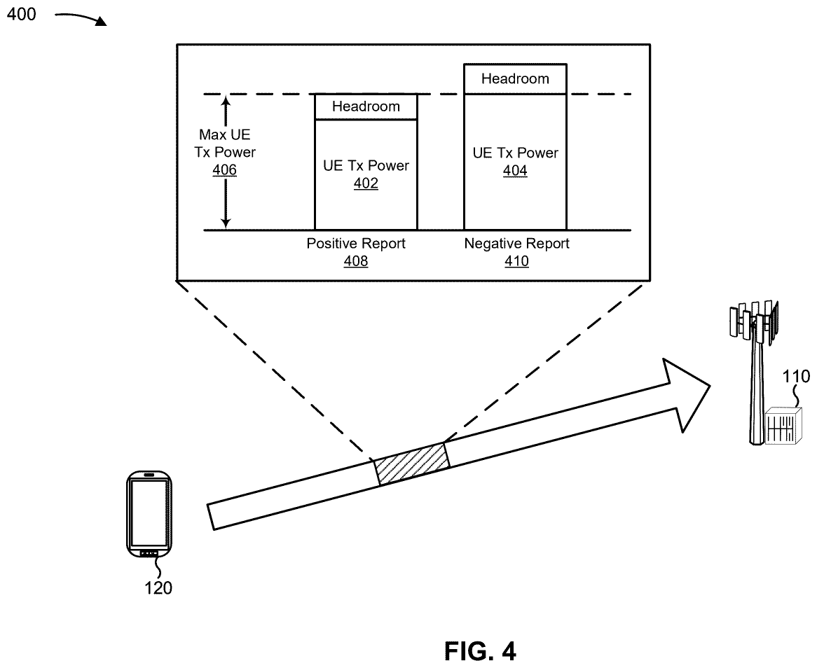

FIG. 4 is a diagram illustrating an example 400 of PHR reporting, in accordance with the present disclosure. Example 400 relates to communication in a wireless network (e.g., wireless communication network 100), such as between a UE 120 and a network node 110.

The UE 120 and the network node 110 may perform wireless communications with one another. Generally, the possible transmit power of the UE 120 may be more constrained than the possible transmit power of the network node 110, due to factors such as UE energy capacity, MPE limitations, and/or mitigation of interference between UEs, among other examples. Furthermore, the UE 120 may be subject to a transmit power limit referred to as a maximum UE transmit power (denoted P_{CMAX}), which may indicate a maximum transmit power (such as −23 decibel milliwatts (dBm), in some examples) at which the UE 120 is permitted to transmit. In some examples, a maximum transmit power may be specific to a cell. The maximum transmit power may vary, among other things, in association with a size of a resource allocation of the UE 120. For example, a larger resource allocation may use a larger transmit power, to achieve a given energy per resource element, than a smaller resource allocation.

PHR reporting provides a mechanism for a UE 120 to report an uplink transmit power of the UE to a scheduling entity such as a network node. The PHR may be derived from the maximum UE transmit power and one or more parameters (e.g., a nominal UE transmit power on a cell, a subcarrier spacing of the cell, allocated resource blocks of the UE, a fractional power control multiplier, a path loss measurement, a modulation and coding scheme offset, a closed loop power control component, or a combination thereof). The PHR may indicate a difference between a current transmit power of the UE (such as a PUSCH transmission power of the UE 120, indicated by reference numbers 402 and 404) and the maximum UE transmit power (P_{CMAX}) 406. The network node 110 may use the PHR for a variety of purposes, such as link adaptation, determination of a modulation and coding scheme, and/or radio resource management, among other examples.

A PHR can indicate a positive PHR 408 or a negative PHR 410. A positive PHR 408 may indicate that the UE 120 can transmit at a higher transmit power while satisfying the maximum UE transmit power 406. A negative PHR 410 may indicate that the UE 120 is transmitting at a transmit power higher than permitted by the maximum UE transmit power 406. The UE 120 may transmit the PHR via MAC signaling, such as a MAC control element (MAC-CE), which may include a bit value that is associated with a table entry that indicates the PHR.

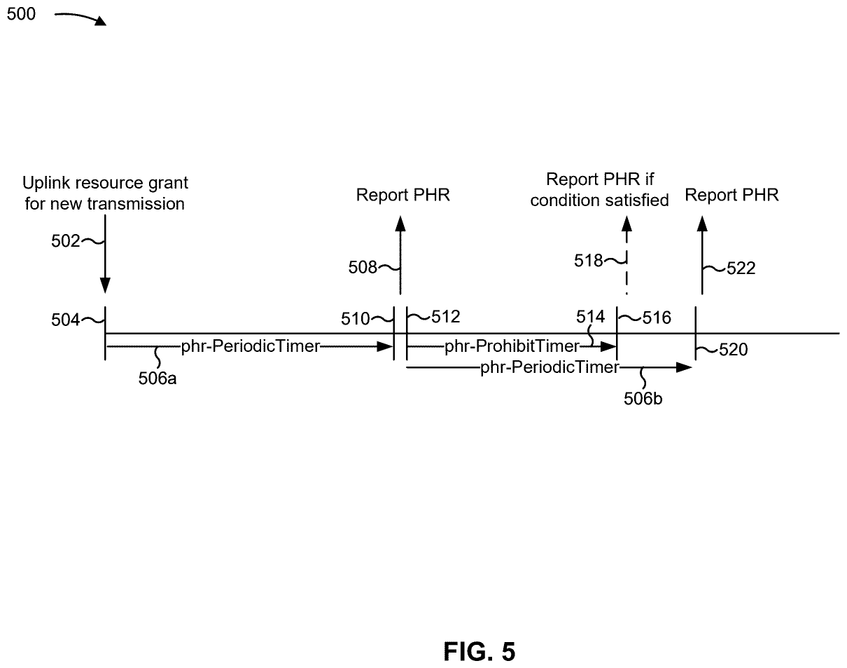

A PHR transmission may be triggered by satisfaction of a condition or by an expiration of a timer. Examples of these triggering conditions are provided in connection with FIG. 5. Some aspects described herein provide for the UE 120 to select (e.g., determine) values for parameters for a condition or a timer (for example, instead of the network node 110 explicitly configuring an exact value of the parameters). Some aspects described herein provide for the network node 110 to transmit a configuration that indicates which parameters relating to PHR reporting are flexible for the UE in which values of these parameters can be selected by the UE 120.

As indicated above, FIG. 4 is provided as an example. Other examples may differ from what is described with respect to FIG. 4.

FIG. 5 is a diagram illustrating an example 500 of conditions and timers associated with PHR transmission, in accordance with the present disclosure.

In example 500, receptions by a UE 120 (for example, transmitted by a network node 110) are illustrated by downward arrows. Transmissions by the UE 120 (for example, received by a network node 110) are illustrated by upward arrows. In example 500, the horizontal axis represents time.

As shown, the UE 120 may receive a grant 502. The grant 502 may include an uplink resource grant for a new transmission. The UE 120 may receive the grant at a time 504.

As shown, the reception of the grant 502 may trigger a first instance of a periodic timer 506a. For example, a length of the periodic timer 506a may be defined by a parameter referred to as phr-PeriodicTimer. The periodic timer 506a may indicate a length of time (e.g., a length of time after the time 504) after which the UE 120 may transmit a PHR 508. For example, expiration of the periodic timer 506a may be a triggering condition for transmission of the PHR 508. As shown, the UE 120 may transmit the PHR 508 at or after a time 510. The PHR (e.g., the PHR 508, the PHR 518, and/or the PHR 522) is described in more detail in connection with FIG. 4.

As shown, at a time 512 (which may be the same time as time 510 or a different, later, time than time 510), the UE 120 may start a prohibit timer 514 and a second instance 506b of a periodic timer. For example, transmission of the PHR 508 may trigger the prohibit timer 514 and the second instance of the periodic timer 506b. The prohibit timer 514 may indicate a length of time within which the UE 120 should not transmit a second PHR after transmitting a first PHR, even if a triggering condition is satisfied within the length of time. Thus, the prohibit timer 514 may reduce or eliminate occurrence of redundant PHR reporting, thereby decreasing overhead. A length of the prohibit timer 514 may be indicated by a parameter phr-ProhibitTimer.

As shown, the prohibit timer 514 may expire at a time 516. As shown, the UE 120 may optionally (as indicated by a dashed line) transmit a PHR 518 at or after the time 516. For example, the UE 120 may transmit the PHR 518 if a triggering condition is satisfied.

One example of a triggering condition is a change in a path loss of the UE 120 satisfying a threshold (such as a threshold defined by a parameter phr-Tx-PowerFactorChange, which may be expressed in decibels (dB)). As another example, a triggering condition may be satisfied when (1) a MAC entity of the UE 120 has uplink resources for a new transmission, (2) uplink resources are allocated for the new transmission, and (3) a required power backoff due to power management (as allowed by a parameter P-MPR_{c}) for a cell associated with the new transmission has changed more than the threshold defined by phr-Tx-PowerFactorChange. As another example, a triggering condition may be satisfied when (1) a MAC entity of the UE 120 has uplink resources for a new transmission on a cell, (2) there is a PUCCH transmission on the cell, and (3) a required power backoff due to power management (as allowed by a parameter P-MPR_{c}) for the cell has changed more than the threshold defined by phr-Tx-PowerFactorChange.

PHR reporting can also be triggered in connection with MPE limitations. Generally, an MPE limitation may impose a limit on the amount of energy radiated in a particular direction by the UE 120, such as in a unit of time. MPE limits may be designed to limit the amount of radiation to which a user of the UE 120 is subjected. In some aspects, if dpc-Reporting-FR1 is configured, the UE 120 may perform PHR reporting when uplink transmissions of the UE 120 exceed an uplink duty cycle associated with a power class of the UE 120, or upon returning to the power class of the UE 120 after the exceeding of the uplink duty cycle. For example, the PHR reporting may include one or more values such as ΔP_{PowerClass}, ΔP_{PowerClass, CA}, ΔP_{PowerClass, EN-DC}, ΔP_{PowerClass, NR-DC}, or a combination thereof. As another example, if mpe-Reporting-FR2 is configured, and a prohibit timer 514 is not running, the UE 120 may perform PHR reporting (which may include an MPE power management minimum power reduction (P-MPR) report) when a measured P-MPR is greater than or equal to a threshold (such as a threshold defined by mpe-Threshold). As another example, if mpe-Reporting-FR2 is configured, and a prohibit timer 514 is not running, the UE 120 may perform PHR reporting (which may include an MPE P-MPR report) when a measured P-MPR change is greater than or equal to a threshold (such as a threshold defined by phr-Tx-PowerFactorChange).

As shown, the second instance of the periodic timer 506b may expire at a time 520. The UE 120 may transmit a PHR 522 at the time 520. For example, the UE 120 may transmit the PHR 522 at the time 520 irrespective of whether a triggering condition (other than expiration of the second instance of the periodic timer 506b) is satisfied in association with the time 520.

In some examples, one or more of the parameters described with regard to FIG. 5 (such as phr-PeriodicTimer, phr-Tx-PowerFactorChange, mpe-Reporting-FR2, phr-ProhibitTimer, or another parameter, threshold, or timer length described with regard to FIG. 5) may be configured via RRC signaling. For example, one or more of these parameters may be configured via an RRC parameter PHR-Config, which may be provided in a cell group configuration (such as a MAC-CellGroupConfig information element).

Aspects described herein provide for a value of one or more of the parameters described in connection with FIG. 5 (such as a timer length or a threshold) to be selected (e.g., determined) by the UE 120 based on the one or more parameters being flexible for the UE. Some aspects described herein provide for the network node 110 to transmit a configuration that indicates which parameters relating to PHR reporting are flexible for the UE in which values of these parameters can be selected by the UE 120.

As indicated above, FIG. 5 is provided as an example. Other examples may differ from what is described with respect to FIG. 5.

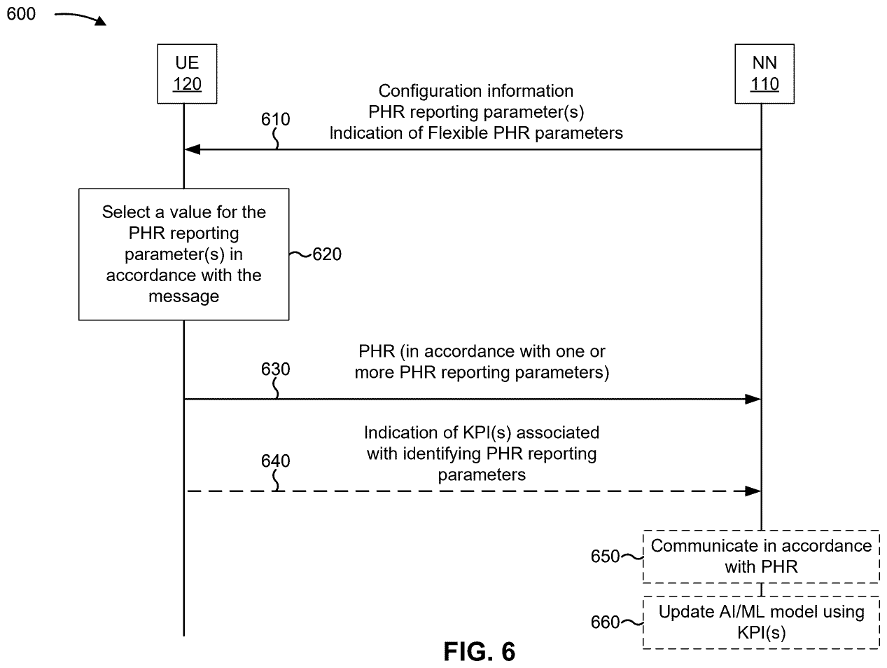

FIG. 6 is a diagram illustrating an example 600 of autonomous PHR reporting, in accordance with the present disclosure. As shown in FIG. 6, a network node (NN) (e.g., network node 110, a CU, a DU, and/or an RU) may communicate with a UE (e.g., UE 120). In some aspects, the network node and the UE may be part of a wireless network (e.g., the wireless communication network 100). The UE 120 and the network node 110 may have established a wireless connection prior to operations shown in FIG. 6.

In some aspects of the example 600, in addition to some PHR reporting procedures, the UE 120 may autonomously determine and/or modify one or more of the PHR reporting timers, triggering conditions, frequency band/power condition specific configurations based on radio conditions, uplink grant patterns, uplink traffic patterns, or internal dynamic information about thermal or smart transmission power adjustment between carriers, as examples, based on an AI/ML model at the UE 120. In some examples, PHR reporting in addition to buffer status reporting may support dual connectivity or secondary cell enablement (e.g., activation/deactivation) or any associated grant patterns.

In some aspects, the UE 120 may transmit, and the network node 110 may receive, a capability report. The UE 120 may transmit the capability report via an uplink communication, a UE assistance information (UAI) communication, an uplink control information (UCI) communication, an uplink MAC control element (MAC-CE) communication, an RRC communication, a physical uplink control channel (PUCCH), and/or a physical uplink shared channel (PUSCH), among other examples. The capability report may indicate one or more parameters associated with respective capabilities of the UE 120. The one or more parameters may be indicated via respective information elements (IEs) included in the capability report.

The capability report may indicate whether the UE supports a feature and/or one or more parameters related to the feature. For example, the capability report may indicate a capability and/or parameter for autonomously reporting a PHR. As another example, the capability report may indicate a capability and/or parameter for selecting (e.g., determining or obtaining an indication of) one or more values for one or more PHR parameters. One or more operations described herein may be based on capability information of the capability report. For example, the UE may perform a communication in accordance with the capability information, or may receive configuration information that is in accordance with the capability information. In some aspects, the capability report may indicate UE support for training an AI/ML model that may inform or support autonomous PHR reporting.

The network node 110 may transmit, and the UE 120 may receive a message 610 which may include, configuration information, PHR reporting parameter(s), and/or a message indicating that triggering PHR reporting, among other examples. In some aspects, the message 610 may include a message indicating that one or more PHR parameters are flexible for the UE. For example, a parameters and/or procedure that that is flexible for the UE may be a flexible procedure or parameter for reporting PHR or triggering a PHR. The flexible reporting procedure may be based on internal knowledge at the UE 120 that, in some aspects, may be derived from an AI/ML model and may support flexible or autonomous determination PHR reporting.

For example, the network node 110 may transmit, and the UE 120 may receive, configuration information. In some aspects, the UE 120 may receive the configuration information via one or more of system information signaling (e.g., a master information block (MIB) and/or a system information block (SIB), among other examples), RRC signaling, MAC signaling (e.g., one or more MAC-CEs), and/or DCI signaling, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to transmit a PHR when one or more of the PHR parameters satisfy a condition. For example, the configuration information may be configured via control signaling such as RRC signaling and may include a flexible PHR reporting parameter configuration (e.g., a flexible or adjustable PHR-Config) or may include multiple PHR reporting parameter configurations (e.g., PHR-Config1, . . . PHR-ConfigN)) which the UE 120 may employ to optimize PHR reporting occurrences. The message may be included in a configuration of a PHR reporting parameter configuration. In some aspects, PHR parameters may generally include parameters that may be used to select (e.g., determine) opportunities for transmitting PHR or may be flexibly configured to optimize the quantity or occurrence of PHR transmissions, while the message may indicate or enable flexibility in the conditions which may trigger a transmission of a PHR.

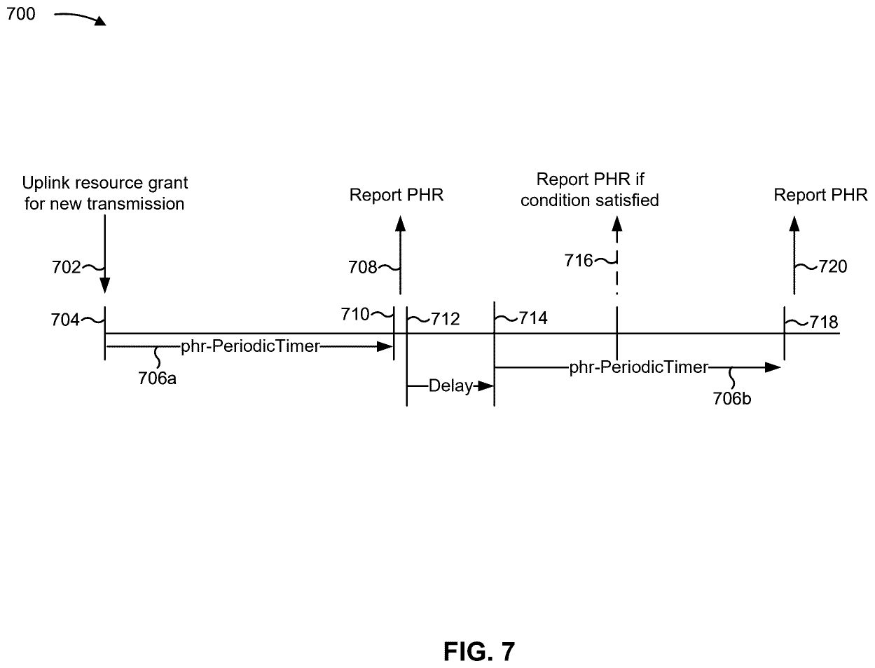

The one or more PHR parameters may include a quantity of occurrences of a PHR control element transmission (e.g., MAC-CE), a pathloss value for PHR transmission (e.g., phr-Tx-PowerFactorChange), a quantity of occurrences of delayed PHR transmission due to a PHR timer (e.g., as described with reference to FIG. 7), a quantity of occurrences of a PHR transmission associated with secondary cell activation or a bandwidth part activation (e.g., a quantity of times that a PHR is transmitted due to secondary cell (SCell) activation vs. activated BWP), a quantity of occurrences of a PHR transmission associated with exceeding a duty cycle (e.g., an autonomous PHR may be triggered when dpc-Reporting-FR1 is activated and PHR has been triggered a certain quantity of times is association with dpc-Reporting-FR1), a variation in timer-based reporting (e.g., the UE 120 may adjust the values of a periodic PHR timer or a prohibit PHR timer), a quantity of occurrences of power condition-based PHR triggering associated with one or more frequency band specifications (e.g., when mpe-Threshold is activated, PHR may be triggered autonomously based on a quantity of times that MPE-based PHR is triggered to meet the regulatory requirements for FR2 band specific communications), a quantity of occurrences of a power condition being satisfied for an activated serving cell associated with the UE (e.g., in association with phr-Tx-PowerFactorChange, a quantity of times that the PHR trigger condition is satisfied in associated with an activated cell in FR2), a distribution of occurrences of a first report type and a second report type (e.g., in twoPHRMode, autonomous PHR may be triggered based on a comparison of the quantity of transmissions a type 1 PHR and a quantity of transmission of a type 3 PHR), a distribution of uplink traffic at the UE associated with a quality of service parameter at the UE (e.g., an autonomous PHR may be transmitted based on a latency experienced by the UE 120 or based on one or more reliability metrics at the UE 120), and/or a statistic associated with buffering at the UE (e.g., an autonomous PHR may be transmitted based on buffering experienced by the UE 120), among other examples. The one or more PHR parameters may serve as a flexible trigger by satisfying a condition for PHR transmission.

As shown by reference number 620, the UE 120 may select a value for the one or more PHR parameters in accordance with the message. For example, the network node 110 may configure the UE 120 with a flexible reporting procedure via the message 610.

In some aspects, the one or more PHR parameters may include a periodic timer, a prohibit timer, a pathloss-based triggering parameter, and/or a power condition (e.g., a power threshold), among other examples. In some aspects, the message may include (e.g., indicate) a range of values for at least one PHR reporting parameter. For example, the one or more PHR parameters may include flexible values with a minimum and/or maximum range for a periodic PHR reporting timer (e.g., phr-PeriodicTimer), a prohibit PHR reporting timer (e.g., phr-ProhibitTimer), pathloss-based PHR triggering (e.g., phr-Tx-PowerFactorChange), and/or a power condition such as an MPE threshold (e.g., mpe-Threshold) for satisfying FR2 MPE requirements versus a current power usage, among other examples.

In some aspects, the one or more PHR parameters may include a reporting mode parameter for reporting PHR for a primary serving cell associated with the UE 120 or for multiple serving cells associated with the UE 120. For example, the one or more PHR parameters may include flexible values for transmitting (e.g., by the UE 120) single-entry PHR mode reporting for single cell scenarios (e.g., a primary cell (PCell)) or for transmitting multiple-entry PHR mode reporting for each activated serving cell. In some aspects, as shown by reference number 620, the UE 120 may select between a single entry PHR type (e.g., used herein interchangeably with “mode”) used to indicated power headroom for a Pcell and a multiple entry PHR type used to indicate power headroom for multiple serving cells.

In some aspects, the one or more PHR parameters may include a PHR reporting mode. For example, the one or more PHR parameters may include a flexible parameter for selecting between PHR Type 1, PHR Type 2, or PHR Type 3 reports based on a combination of internal knowledge at the UE 120, the AI/ML model, and/or an expected traffic pattern, among other examples. In some aspects, at 620, the UE 120 may select the PHR reporting mode from a plurality of PHR reporting modes (e.g., PHR Type 1 or 2 or 3) according to a traffic pattern associated with the UE 120. In some examples, Type 1 reporting may reflect the power headroom assuming PUSCH-only transmission, while Type-2 reporting may assume combined PUSCH and PUCCH transmission, and Type-3 reporting may be associated with SRS transmission. For example, the UE 120 may select a PHR reporting mode based on what type of UL traffic is scheduled.

In some aspects, the one or more PHR parameters may include a PHR reporting trigger parameter associated with a power condition at the UE 120. In some aspects, as represented by reference number 620, the UE 120 may select the PHR reporting trigger parameter from a set of PHR reporting triggers, in association with a power mode or operation condition, according to the power condition at the UE 120. For example, the one or more PHR parameters may include a flexible parameter for transmitting or triggering PHR reporting due to internal variations of power at the UE 120. The internal variations of power at the UE 120 may be due to triggers such as “smart transmission”, where power may be reserved for some guaranteed service during a transmission window to satisfy a power condition (e.g., mpe-Threshold) or a thermal mode of operation.

In some aspects, the one or more PHR parameters may include a PHR reporting trigger parameter associated with one or more of a dual connectivity mode (e.g., NR-NR Dual Connectivity (NRDC) or E-UTRAN NR Dual Connectivity (ENDC)) of the UE 120 or a dual band carrier aggregation mode of the UE 120. In some aspects, as shown by reference number 620, the UE 120 may select the PHR reporting trigger parameter from a set of PHR reporting triggers according to the dual connectivity mode of the UE 120. For example, the one or more PHR parameters may include a flexible parameter for transmitting or triggering PHR reporting due to one or more of power sharing between carriers during a dual connectivity mode of operation or a preferential condition for one or more secondary cell groups over a master cell group in some specific service use cases.

In some aspects, the one or more PHR parameters may include a flexible parameter for transmitting or triggering PHR reporting due to power sharing between carriers during a dual band carrier aggregation mode of the UE 120. For example, the UE 120 may communicate using multiple frequency bands (e.g., FR1+FR2), and a spectral efficiency of each frequency may be different (e.g., similarly to dual connectivity). Therefore, a dual band carrier aggregation parameter may be a flexible parameter for triggering autonomous PHR reporting. For example, the UE 120 may transmit an autonomous PHR when a spectral efficiency of one or both of the frequency bands satisfies a threshold.

In some aspects, the one or more PHR parameters may include a PHR reporting trigger parameter associated with uplink traffic at the UE 120. In some aspects, at 620, the UE 120 may select the PHR reporting trigger parameter from a set of PHR reporting triggers, according to the uplink traffic at the UE and a service requirement of the UE. For example, the one or more PHR parameters may include a flexible parameter for transmitting or triggering PHR reporting based on an uplink traffic pattern obtained by a modem of the UE 120, derived based on modem or application specific knowledge at the UE 120, or extrapolated based on service requirements (e.g., service requirements associated with periodic, bursty, or extended reality-type traffic) of the UE 120. For example, the UE 120 may transmit an autonomous PHR more, or less, frequently (e.g., which may be determined using the AI/ML model) during periodic uplink traffic, than during bursty traffic or extended-reality-type traffic, or vice versa. As traffic variability increases at the UE 120 by transitioning through such traffic patterns, the UE 120 may benefit from autonomously choosing when to transmit PHR to take advantage of available uplink bandwidth in traffic patterns associated with less frequent or smaller messages.

In some aspects, the message 610 may include a range of values for a periodic timer, a prohibit timer, a pathloss-based triggering parameter, and/or a power threshold, among other examples. In some aspects, at 620, the UE 120 may select the value for the one or more PHR parameters by selecting a value, from the range of values, for a PHR reporting parameter (e.g., the periodic timer, the prohibit timer, the pathloss-based triggering parameter, and/or the power threshold). For example, based on a prediction or inference of the uplink transmission characteristics or patterns with the associated quality of service at the UE 120, the UE 120 may determine a PHR timer value (e.g., a value for phr-PeriodicTimer or phr-ProhibitTimer or mpe-ProhibitTimer). For example, as quality of service at the UE 120 increases, the UE may select a smaller timer value in order to transmit PHR more frequently, or vice versa. In some aspects, the UE 120 may determine a PHR timer value when enabling, initiating, or restarting the PHR timer.

In some aspects, as shown by reference number 620, the UE 120 may select a triggering condition for the PHR. For example, based on a prediction or inference of the uplink transmission characteristics or patterns with the associated quality of service at the UE 120, the UE 120 may determine whether to enable or disable a timer (e.g., phr-PeriodicTimer or phr-ProhibitTimer or mpe-ProhibitTimer). For example, the UE 120 may delay a start of a periodic timer after a PHR transmission without the prohibit timer, as discussed below with reference to FIG. 7.

In some aspects, the UE 120 may toggle an on or off state of the one or more PHR parameters. For example, based on a prediction or inference of the uplink transmission characteristics or patterns with the associated quality of service at the UE 120, the UE 120 may determine a triggering condition (e.g., a value for phr-Tx-PowerFactorChange or mpe-Threshold).

In some aspects, the selection of the value of the one or more PHR parameters performed by the UE 120 at 620 may be based on monitoring one or more PHR metrics (e.g., PHR key performance indicator (KPI) metrics). In some aspects, the UE 120 may select (e.g., determine or obtain an indication of) one or more values of the one or more PHR parameters based on the monitoring. For example, the UE 120 may train the AI/ML model based on the monitoring or may infer that a PHR is to be triggered based on the monitoring of the PHR KPIs.

For example, in a first aspect, the selecting (e.g., determining or obtaining an indication of) the value(s) for one or more PHR parameters may be associated with a quantity of occurrences of a PHR control element transmission. For example, the PHR KPI metrics may include a number (e.g., used herein interchangeably with “quantity”) of occurrences that PHR MAC-CE transmission is triggered by phr-Tx-PowerFactorChange in pathloss.

In a second aspect, the selecting (e.g., determining or obtaining an indication of) the value(s) for one or more PHR parameters may be associated with a pathloss value for a PHR transmission. For example, the pathloss value may include a distribution of pathloss values occurring during PHR transmission such that the UE 120 may chose an event threshold for future PHR transmissions most suitable for optimizing pathloss.

In a third aspect, the selecting (e.g., determining or obtaining an indication of) the value(s) for one or more PHR parameters may be associated with a quantity of occurrences of delayed PHR transmission due to a PHR timer. For example, the PHR KPI metrics may include a number of occurrences in which PHR transmission is gated (e.g., delayed) due to the prohibit timer (e.g., to optimize the prohibit timer value or range).

In a fourth aspect, the selecting (e.g., determining or obtaining an indication of) the value(s) for one or more PHR parameters may be associated with a quantity of occurrences of a PHR transmission associated with secondary cell activation or a bandwidth part activation. For example, the PHR KPI metrics may include a number of occurrences in which a PHR transmission is triggered due to an Scell activation versus activated BWP.

In a fifth aspect, the selecting (e.g., determining or obtaining an indication of) the value(s) for one or more PHR parameters may be associated with a quantity of occurrences of a PHR transmission associated with exceeding a duty cycle. For example, the PHR KPI metrics may include a number of times that PHR transmission is triggered due to a duty cycle being exceeded in the case that dpc-Reporting-FR1 is enabled.

In a sixth aspect, the selecting (e.g., determining or obtaining an indication of) the value(s) for one or more PHR parameters may be associated with a variation in timer-based reporting. For example, the PHR KPI metrics may include a variation across periodic timer reporting (e.g., to optimize the periodic timer value or range).

In a seventh aspect, the selecting (e.g., determining or obtaining an indication of) the value(s) for one or more PHR parameters may be associated with a quantity of occurrences of power condition-based PHR report triggering associated with one or more frequency band specifications. With respect to the information element mpe-Threshold, for example, the PHR KPI metrics may include a number of times that MPE-based PHR reporting is triggered to meet regulatory requirements for some frequency bands (e.g., FR2).

In a seventh aspect, the selecting (e.g., determining or obtaining an indication of) the value(s) for one or more PHR parameters may be associated with a quantity of occurrences of a power condition being satisfied for an activated serving cell associated with the UE 120. With respect to the information element phr-Tx-PowerFactorChange, for example, the PHR KPI metrics may include a number of times that power condition-based PHR reporting is triggered (e.g., a power threshold is met) for an activated cell for one or more frequency bands (e.g., FR2 bands).

In an eighth aspect, the selecting (e.g., determining or obtaining an indication of) the value(s) for one or more PHR parameters may be associated with a distribution of occurrences of a first report type and a second report type. For example, when a multi-PHR mode (e.g., twoPHRMode) is enabled, the PHR KPI metrics may include a distribution between Type 1 and Type 3 reports.

In a ninth aspect, the selecting (e.g., determining or obtaining an indication of) the value(s) for one or more PHR parameters may be associated with a distribution of one or more of uplink traffic at the UE 120, or a quality of service (QoS) parameter at the UE 120. As an example, the PHR KPI metrics may include a comparison between a traffic distribution and one or more QoS parameters (e.g., a comparison between latency or reliability). As another example, the PHR KPI metrics may include one or more of a distribution of traffic or a distribution of QoS parameters.

In a tenth aspect, the selecting (e.g., determining or obtaining an indication of) the value(s) for one or more PHR parameters may be associated with a statistic associated with buffering at the UE 120. For example, the PHR KPI metrics may include data statistics in a data buffer of the UE 120 or a quantity of buffer status reports (BSRs) transmitted by the UE 120.

The UE 120 may use the discussed metrics and KPIs for training the AI/ML model at the UE 120 to refine the further UE-based PHR trigger procedures, and may report the metrics and KPIs to the network node 110 for training the AI/ML model at the network node 110 to aid in determining a most suitable configuration.

Based on the AI/ML model, the UE 120 may autonomously choose different values for the PHR triggering timers, pathloss thresholds (e.g., triggering an autonomous PHR that preempts a further increase in pathloss such that the PHR is transmitted at a certain value), MPE/band specific triggers, thermal metrics (e.g., where transmitting a PHR may overload a thermal requirement of the UE 120), and/or smart transmission related metrics (e.g., to enable a more optimal uplink scheduling pattern from the network node 110, as well as better spectral efficiency), among other examples. That is, based on the AI/ML model, the UE may determine that certain conditions may benefit from triggering PHR at different values of the triggering timers (e.g., correlated to quality of service experienced by the UE 120, which may provide opportunities to trigger the PHR reports based on a criticality of a message, variation in power perspective of the UE 120, among other examples).

In some aspects, the UE 120 may select (e.g., determine or obtain an indication of) one or more values for the one or more PHR parameters that are flexible for the UE using an AI/ML model.

In some aspects, the UE 120 may train the AI/ML model using a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power-condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, and/or a statistic associated with buffering at the UE, among other examples.

The UE 120 may transmit a PHR 630 in accordance with the one or more PHR parameters. For example, the UE may transmit the PHR 630 (e.g., as described with reference to FIG. 4) when at least one of the one or more PHR parameters satisfies a respective threshold or condition.

In some aspects, the UE 120 may receive a request to report PHR, where the request is associated with an uplink transmission grant. In some aspects, the UE 120 may receive a configuration that overrides a previous configuration of the UE 120 and enables the one or more PHR parameters that are flexible for the UE. In some aspects, the UE 120 may receive an indication to toggle an activation state of the one or more PHR parameters that are flexible for the UE.

In some aspects, the UE 120 may transmit an indication 640 of one or more KPI(s) associated with selecting (e.g., determining or obtaining an indication of) the one or more values of one or more PHR parameters. For example, the UE 120 may transmit an indication of a quantity of occurrences of a PHR control element transmission, a pathloss value for a PHR transmission, a quantity of occurrences of a delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, and/or a statistic associated with buffering at the UE.

In some aspects, the network node 110 may communicate in accordance with the PHR report, as shown by reference number 650. For example, the network node 110 may schedule more or fewer uplink messages at the UE 120 based on whether the PHR 630 is a positive PHR or a negative PHR, as described with reference to FIG. 4.

In some aspects, the network node 110 may update (e.g., train) the AI/ML model using KPI(s) (e.g., received from the UE 120, as described in connection with the indication 640), as shown by reference number 660. For example, the network node may train an AI/ML model local to the network node 110 such that the network node 110 may select (e.g., determine) opportunities for more efficient uplink scheduling.

As indicated above, FIG. 6 is provided as an example. Other examples may differ from what is described with respect to FIG. 6.

FIG. 7 is a diagram illustrating an example 700 associated with AI/ML-based PHR reporting, in accordance with the present disclosure. In example 700, receptions by a UE 120 (for example, transmitted by a network node 110) are illustrated by downward arrows. Transmissions by the UE 120 (for example, received by a network node 110) are illustrated by upward arrows. In example 700, the horizontal axis represents time.

As shown, the UE 120 may receive a grant 702. The grant 702 may include an uplink resource grant for a new transmission. The UE 120 may receive the grant at a time 704.

As shown, the reception of the grant 702 may trigger a first instance of a periodic timer 706a. For example, a length of the periodic timer 706a may be defined by a parameter referred to as phr-PeriodicTimer, which may be an example of a flexible parameter. In the example 700, the parameter phr-PeriodicTimer may be a PHR reporting parameter as described herein and may be a flexible parameter. For example, phr-PeriodicTimer may indicate a range of values for the periodic timer from which a UE may select a value based on one or more conditions at the UE or based on the AI/ML model. For example, based on at least one of a prediction or inference from uplink transmission characteristics associated with a QoS at the UE 120, the UE 120 may select the time value of the phr-PeriodicTimer.

The periodic timer 706a may indicate a length of time (after the time 704) after which the UE 120 may transmit a PHR 708. For example, expiration of the periodic timer 706a may be a triggering condition for transmission of the PHR 708. As shown, the UE 120 may transmit the PHR 708 at or after a time 710. The PHR (e.g., the PHR 708, the PHR 716, and the PHR 720) is described in more detail in connection with FIG. 4.

As shown, at a time 712 (which may be the same time as time 710 or a different, later, time than time 710), the UE 120 may enable or disable the periodic timer 706b (e.g., delaying the starting of the periodic timer 706b after a PHR transmission without the prohibit timer).

For example, the UE 120 may determine to delay a second instance of the periodic timer 706b until a time 714 based on a prediction or inference of uplink transmission characteristics or patterns with the associated QoS at the UE 120, thereby bypassing initiation or use of a prohibit timer as described with reference to FIG. 5.

As shown, the UE 120 may optionally (as indicated by a dashed line) transmit a PHR 716 at or after the time 714. For example, the UE 120 may transmit the PHR 518 if a triggering condition is satisfied (e.g., any of the triggering conditions described herein, and particularly with reference to FIGS. 5 and 6).

As shown, the second instance of the periodic timer 706b may expire at a time 718. The UE 120 may transmit a PHR 720 at or after the time 718. For example, the UE 120 may transmit the PHR 720 at the time 718, irrespective of whether a triggering condition (other than expiration of the second instance of the periodic timer 706b) is satisfied in association with the time 718.

In some aspects, one or more of the parameters described with regard to FIG. 7 (such as phr-PeriodicTimer, phr-Tx-PowerFactorChange, mpe-Reporting-FR2, phr-ProhibitTimer, or another parameter, threshold, or timer length described with regard to FIG. 7) may be configured via RRC signaling. For example, one or more of these parameters may be configured via an RRC parameter PHR-Config, which may be provided in a cell group configuration (such as a MAC-CellGroupConfig information element).

Aspects described herein provide for a value of one or more of the parameters described in connection with FIG. 7 (such as a timer length or a threshold) to be selected by the UE 120 based on the one or more parameters being flexible for the UE. Some aspects described herein provide for the network node 110 to transmit a configuration that indicates which parameters relating to PHR reporting are flexible for the UE in which values of these parameters can be selected by the UE 120.

As indicated above, FIG. 7 is provided as an example. Other examples may differ from what is described with respect to FIG. 7.

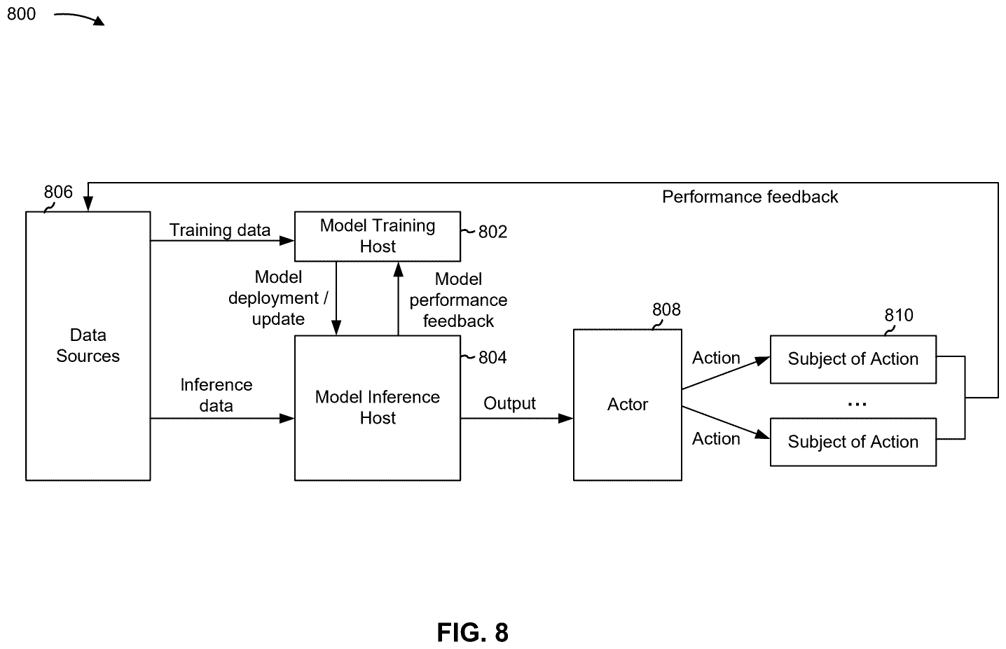

FIG. 8 is a diagram illustrating an example architecture 800 of a functional framework for radio access network (RAN) intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI-enabled optimization) have been utilized or studied to identify the benefits of AI-enabled RAN through possible use cases (e.g., beam management, energy saving, load balancing, mobility management, and/or coverage optimization, among other examples). In one example, as shown by the architecture 800, a functional framework for RAN intelligence may include multiple logical entities, such as a model training host 802, a model inference host 804, data sources 806, and an actor 808.

The model inference host 804 may be configured to run an AI/ML model based on inference data provided by the data sources 806, and the model inference host 804 may produce an output (e.g., a prediction) with the inference data input to the actor 808. The actor 808 may be an element or an entity of a core network or a RAN. For example, the actor 808 may be a UE, a network node, a base station (e.g., a gNB), a CU, a DU, and/or an RU, among other examples. In addition, the actor 808 may also depend on the type of tasks performed by the model inference host 804, the type of inference data provided to the model inference host 804, and/or the type of output produced by the model inference host 804. For example, if the output from the model inference host 804 is associated with beam management, then the actor 808 may be a UE, a DU, or an RU. In other examples, if the output from the model inference host 804 is associated with Tx/Rx scheduling, then the actor 808 may be a CU or a DU.

After the actor 808 receives an output from the model inference host 804, the actor 808 may determine whether to act based on the output. For example, if the actor 808 is a DU or an RU and the output from the model inference host 804 is associated with beam management, the actor 808 may determine whether to change/modify a Tx/Rx beam based on the output. If the actor 808 determines to act based on the output, the actor 808 may indicate the action to at least one subject of action 810. For example, if the actor 808 determines to change/modify a Tx/Rx beam for a communication between the actor 808 and the subject of action 810 (e.g., a UE 120), then the actor 808 may transmit a beam (re-)configuration or a beam switching indication to the subject of action 810. The actor 808 may modify its Tx/Rx beam based on the beam (re-)configuration, such as by switching to a new Tx/Rx beam or applying different parameters for a Tx/Rx beam, among other examples. As another example, the actor 808 may be a UE and the output from the model inference host 804 may be associated with beam management. For example, the output may be one or more predicted measurement values for one or more beams. The actor 808 (e.g., a UE) may determine that a measurement report (e.g., a Layer 1 (L1) RSRP report) is to be transmitted to a network node 110.

The data sources 806 may also be configured for collecting data that is used as training data for training an AI/ML model or as inference data for feeding an AI/ML model inference operation. For example, the data sources 806 may collect data from one or more core network and/or RAN entities, which may include the subject of action 810, and provide the collected data to the model training host 802 for AI/ML model training. For example, after a subject of action 810 (e.g., a UE 120) receives a beam configuration from the actor 808, the subject of action 810 may provide performance feedback associated with the beam configuration to the data sources 806, where the performance feedback may be used by the model training host 802 for monitoring or evaluating the AI/ML model performance, such as whether the output (e.g., prediction) provided to the actor 808 is accurate. In some examples, if the output provided by the actor 808 is inaccurate (or the accuracy is below an accuracy threshold), then the model training host 802 may determine to modify or retrain the AI/ML model used by the model inference host, such as via an AI/ML model deployment/update.

The data sources 806 may collect data, such as one or more of a quantity of occurrences of a PHR control element transmission, a pathloss value for a PHR transmission, a quantity of occurrences of a delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE, as described herein. Collectively, the data collected by the data sources 806 for autonomous PHR reporting may be referred to as PHR KPIs. The data sources may provide the collected data to the model training host 802 for AI/ML model training. As a result, the actor 808 may select a value of the one or more PHR parameters that are flexible for the UE (e.g., PHR KPIs) in accordance with the message described herein by using the trained AI/ML model (e.g., the actor 808 (such as a UE) may obtain an indication of the value(s) of the one or more PHR parameters from the trained AI/ML model).

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with autonomous PHR reporting.

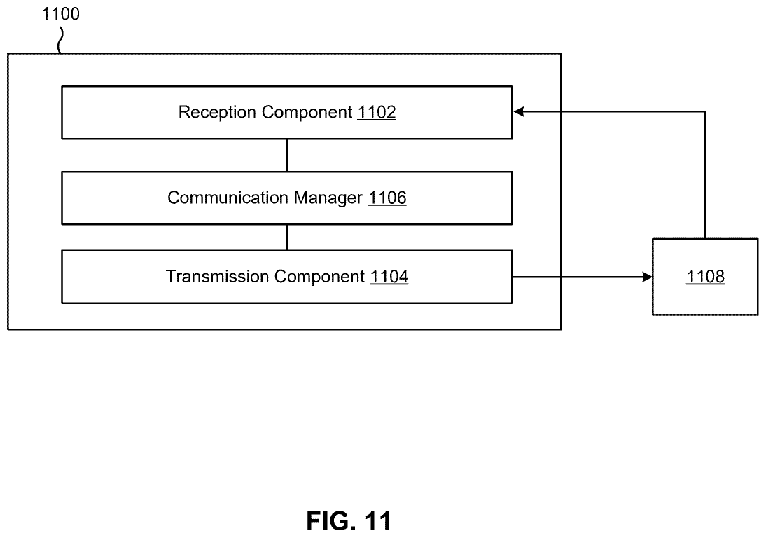

As shown in FIG. 9, in some aspects, process 900 may include receiving, from a network node, a message indicating that one or more PHR parameters are flexible for the UE (block 910). For example, the UE (e.g., using reception component 1102 and/or communication manager 1106, depicted in FIG. 11) may receive, from a network node, a message indicating that one or more PHR parameters are flexible for the UE, as described above in connection with the message 610 and/or FIG. 6.

As further shown in FIG. 9, in some aspects, process 900 may include selecting a value for the one or more PHR parameters in accordance with the message (block 920). For example, the UE (e.g., using communication manager 1106, depicted in FIG. 11) may select a value for the one or more PHR parameters in accordance with the message, as described above with regard to reference number 620 of FIG. 6.

As further shown in FIG. 9, in some aspects, process 900 may include transmitting a PHR in accordance with the one or more PHR parameters (block 930). For example, the UE (e.g., using transmission component 1104 and/or communication manager 1106, depicted in FIG. 11) may transmit a PHR in accordance with the one or more PHR parameters, as described above in connection with the PHR 630 and/or FIG. 6.

Process 900 may include additional aspects, such as any single aspect or any combination of aspects described below and/or in connection with one or more other processes described elsewhere herein.

In a first aspect, the one or more PHR parameters include one or more of a periodic timer, a prohibit timer, a pathloss-based triggering parameter, or a power threshold.

In a second aspect, alone or in combination with the first aspect, the message indicates a range of values for the one or more PHR parameters, and wherein the value is included in the range of values.

In a third aspect, alone or in combination with one or more of the first and second aspects, the one or more PHR parameters include a reporting mode parameter for reporting PHR for a primary serving cell associated with the UE or for multiple serving cells associated with the UE.

In a fourth aspect, alone or in combination with one or more of the first through third aspects, process 900 includes selecting between a single entry PHR type and a multiple entry PHR type.

In a fifth aspect, alone or in combination with one or more of the first through fourth aspects, the one or more PHR parameters include a PHR reporting mode.

In a sixth aspect, alone or in combination with one or more of the first through fifth aspects, process 900 includes selecting the PHR reporting mode from a plurality of PHR reporting modes according to a traffic pattern associated with the UE.

In a seventh aspect, alone or in combination with one or more of the first through sixth aspects, the one or more PHR parameters include a PHR reporting trigger parameter associated with a power condition at the UE.

In an eighth aspect, alone or in combination with one or more of the first through seventh aspects, process 900 includes selecting the PHR reporting trigger parameter from a set of PHR reporting triggers, in association with a power mode of operation condition, according to the power condition at the UE.

In a ninth aspect, alone or in combination with one or more of the first through eighth aspects, the one or more PHR parameters include a PHR reporting trigger parameter associated with one or more of a dual connectivity mode of the UE or a dual band carrier aggregation mode of the UE.

In a tenth aspect, alone or in combination with one or more of the first through ninth aspects, process 900 includes selecting the PHR reporting trigger parameter from a set of PHR reporting triggers according to the dual connectivity mode of the UE.

In an eleventh aspect, alone or in combination with one or more of the first through tenth aspects, the one or more PHR parameters include a PHR reporting trigger parameter associated with uplink traffic at the UE.

In a twelfth aspect, alone or in combination with one or more of the first through eleventh aspects, process 900 includes selecting the PHR reporting trigger parameter from a set of PHR reporting triggers according to the uplink traffic at the UE and a service requirement of the UE.

In a thirteenth aspect, alone or in combination with one or more of the first through twelfth aspects, the message indicates a range of values for at least one of a periodic timer, a prohibit timer, a pathloss-based triggering parameter, or a power threshold, and selecting the value for the one or more PHR parameters includes selecting the value, from the range of values, for the at least one of the periodic timer, the prohibit timer, the pathloss-based triggering parameter, or the power threshold.

In a fourteenth aspect, alone or in combination with one or more of the first through thirteenth aspects, process 900 includes selecting a triggering condition for the PHR.

In a fifteenth aspect, alone or in combination with one or more of the first through fourteenth aspects, process 900 includes toggling an on or off state of the one or more PHR parameters.

In a sixteenth aspect, alone or in combination with one or more of the first through fifteenth aspects, selecting the value for the one or more PHR parameters is associated with a quantity of occurrences of a PHR control element transmission.

In a seventeenth aspect, alone or in combination with one or more of the first through sixteenth aspects, selecting the value for the one or more PHR parameters is associated with a pathloss value for a PHR transmission.

In an eighteenth aspect, alone or in combination with one or more of the first through seventeenth aspects, selecting the value for the one or more PHR parameters is associated with a quantity of occurrences of delayed PHR transmission due to a PHR timer.

In a nineteenth aspect, alone or in combination with one or more of the first through eighteenth aspects, selecting the value for the one or more PHR parameters is associated with a quantity of occurrences of a PHR transmission associated with secondary cell activation or a bandwidth part activation.

In a twentieth aspect, alone or in combination with one or more of the first through nineteenth aspects, selecting the value for the one or more PHR parameters is associated with a quantity of occurrences of a PHR transmission associated with exceeding a duty cycle.

In a twenty-first aspect, alone or in combination with one or more of the first through twentieth aspects, selecting the value for the one or more PHR parameters is associated with a variation in timer-based reporting.

In a twenty-second aspect, alone or in combination with one or more of the first through twenty-first aspects, selecting the value for the one or more PHR parameters is associated with a quantity of occurrences of power condition-based PHR triggering associated with one or more frequency band specifications.

In a twenty-third aspect, alone or in combination with one or more of the first through twenty-second aspects, selecting the value for the one or more PHR parameters is associated with a quantity of occurrences of a power condition being satisfied for an activated serving cell associated with the UE.

In a twenty-fourth aspect, alone or in combination with one or more of the first through twenty-third aspects, selecting the value for the one or more PHR parameters is associated with a distribution of occurrences of a first report type and a second report type.

In a twenty-fifth aspect, alone or in combination with one or more of the first through twenty-fourth aspects, selecting the value for the one or more PHR parameters is associated with a distribution of one or more of uplink traffic at the UE, or a quality of service parameter at the UE.

In a twenty-sixth aspect, alone or in combination with one or more of the first through twenty-fifth aspects, selecting the value for the one or more PHR parameters is associated with a statistic associated with buffering at the UE.

In a twenty-seventh aspect, alone or in combination with one or more of the first through twenty-sixth aspects, process 900 includes receiving a request to report PHR, wherein the request is associated with an uplink transmission grant.

In a twenty-eighth aspect, alone or in combination with one or more of the first through twenty-seventh aspects, process 900 includes receiving a configuration that overrides a previous configuration of the UE and enables the one or more PHR parameters that are flexible for the UE.

In a twenty-ninth aspect, alone or in combination with one or more of the first through twenty-eighth aspects, process 900 includes receiving an indication to toggle an activation state of the one or more PHR parameters that are flexible for the UE.

In a thirtieth aspect, alone or in combination with one or more of the first through twenty-ninth aspects, the value for one or more PHR parameters is selected using an AI/ML model.

In a thirty-first aspect, alone or in combination with one or more of the first through thirtieth aspects, process 900 includes receiving information indicating the AI/ML model.

In a thirty-second aspect, alone or in combination with one or more of the first through thirty-first aspects, process 900 includes training the AI/ML model using at least one of a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

In a thirty-third aspect, alone or in combination with one or more of the first through thirty-second aspects, process 900 includes transmitting an indication of at least one of a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with autonomous PHR reporting.

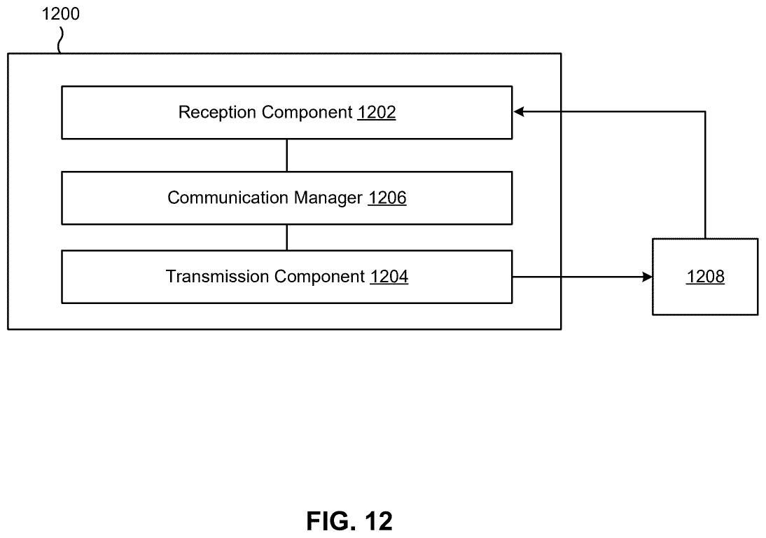

As shown in FIG. 10, in some aspects, process 1000 may include transmitting, to a UE, a message indicating that one or more PHR parameters are flexible for the UE (block 1010). For example, the network node (e.g., using transmission component 1204 and/or communication manager 1206, depicted in FIG. 12) may transmit, to a UE, a message indicating that one or more PHR reporting parameters, as described above in connection with the message 610 and/or FIG. 6.

As further shown in FIG. 10, in some aspects, process 1000 may include receiving a PHR in accordance with the one or more PHR parameters (block 1020). For example, the network node (e.g., using reception component 1202 and/or communication manager 1206, depicted in FIG. 12) may receive a PHR in accordance with the one or more PHR parameters, as described above in connection with the PHR 630 and/or FIG. 6.

As further shown in FIG. 10, in some aspects, process 1000 may include communicating in accordance with the PHR (block 1030). For example, the network node (e.g., using reception component 1202, transmission component 1204, and/or communication manager 1206, depicted in FIG. 12) may communicate in accordance with the PHR report, as described above with regard to reference number 650 of FIG. 6.

Process 1000 may include additional aspects, such as any single aspect or any combination of aspects described below and/or in connection with one or more other processes described elsewhere herein.

In a first aspect, the one or more PHR parameters include one or more of a periodic timer, a prohibit timer, a pathloss-based triggering parameter, or a power threshold.

In a second aspect, alone or in combination with the first aspect, the message indicates a range of values for the one or more PHR parameters, and wherein the value is included in the range of values.

In a third aspect, alone or in combination with one or more of the first and second aspects, the one or more PHR parameters include a reporting mode parameter for reporting PHR for a primary serving cell associated with the UE or for multiple serving cells associated with the UE.

In a fourth aspect, alone or in combination with one or more of the first through third aspects, the one or more PHR parameters that are flexible for the UE include at least one of a single entry PHR type or a multiple entry PHR type.

In a fifth aspect, alone or in combination with one or more of the first through fourth aspects, the one or more PHR parameters include a PHR type.

In a sixth aspect, alone or in combination with one or more of the first through fifth aspects, the one or more PHR parameters that are flexible for the UE include a plurality of PHR reporting modes each associated with a respective traffic pattern at the UE.

In a seventh aspect, alone or in combination with one or more of the first through sixth aspects, the one or more PHR parameters include a PHR reporting trigger parameter associated with a power condition at the UE.

In an eighth aspect, alone or in combination with one or more of the first through seventh aspects, the one or more PHR parameters that are flexible for the UE include a set of PHR reporting triggers, in association with a power mode of operation condition, according to the power condition at the UE.

In a ninth aspect, alone or in combination with one or more of the first through eighth aspects, the one or more PHR parameters include a PHR reporting trigger parameter associated with one or more of a dual connectivity mode of the UE or a dual band carrier aggregation mode of the UE.

In a tenth aspect, alone or in combination with one or more of the first through ninth aspects, the UE may select the PHR reporting trigger parameter from a set of PHR reporting triggers according to the dual connectivity mode of the UE.

In an eleventh aspect, alone or in combination with one or more of the first through tenth aspects, the one or more PHR parameters include a PHR reporting trigger parameter associated with uplink traffic at the UE.

In a twelfth aspect, alone or in combination with one or more of the first through eleventh aspects, the message indicates a set of selectable PHR reporting triggers associated with the uplink traffic at the UE and a service requirement of the UE, and the set of selectable PHR reporting triggers includes the PHR reporting trigger parameter.

In a thirteenth aspect, alone or in combination with one or more of the first through twelfth aspects, the message indicates a range of values for at least one of a periodic timer, a prohibit timer, a pathloss-based triggering parameter, or a power threshold.

In a fourteenth aspect, alone or in combination with one or more of the first through thirteenth aspects, the message indicates a selectable triggering condition for the PHR.

In a fifteenth aspect, alone or in combination with one or more of the first through fourteenth aspects, the message indicates a togglable on or off state of the one or more PHR parameters.

In a sixteenth aspect, alone or in combination with one or more of the first through fifteenth aspects, the one or more PHR parameters that are flexible for the UE are associated with a quantity of occurrences of a PHR control element transmission.

In a seventeenth aspect, alone or in combination with one or more of the first through sixteenth aspects, the one or more PHR parameters that are flexible for the UE are associated with a pathloss value for a PHR transmission.

In an eighteenth aspect, alone or in combination with one or more of the first through seventeenth aspects, the one or more PHR parameters that are flexible for the UE are associated with a quantity of occurrences of delayed PHR transmission due to a PHR timer.

In a nineteenth aspect, alone or in combination with one or more of the first through eighteenth aspects, the one or more PHR parameters that are flexible for the UE are associated with a quantity of occurrences of a PHR transmission associated with secondary cell activation or a bandwidth part activation.

In a twentieth aspect, alone or in combination with one or more of the first through nineteenth aspects, the one or more PHR parameters that are flexible for the UE are associated with a quantity of occurrences of a PHR transmission associated with exceeding a duty cycle.

In a twenty-first aspect, alone or in combination with one or more of the first through twentieth aspects, the one or more PHR parameters that are flexible for the UE are associated with a variation in timer-based reporting.

In a twenty-second aspect, alone or in combination with one or more of the first through twenty-first aspects, the one or more PHR parameters that are flexible for the UE are associated with a quantity of occurrences of power condition-based PHR triggering associated with one or more frequency band specifications.

In a twenty-third aspect, alone or in combination with one or more of the first through twenty-second aspects, the one or more PHR parameters that are flexible for the UE are associated with a quantity of occurrences of a power condition being satisfied for an activated serving cell associated with the UE.

In a twenty-fourth aspect, alone or in combination with one or more of the first through twenty-third aspects, the one or more PHR parameters that are flexible for the UE are associated with a distribution of occurrences of a first report type and a second report type.

In a twenty-fifth aspect, alone or in combination with one or more of the first through twenty-fourth aspects, the one or more PHR parameters that are flexible for the UE are associated with a distribution of one or more of uplink traffic at the UE, or a quality of service parameter at the UE.

In a twenty-sixth aspect, alone or in combination with one or more of the first through twenty-fifth aspects, the one or more PHR parameters that are flexible for the UE are associated with a statistic associated with buffering at the UE.

In a twenty-seventh aspect, alone or in combination with one or more of the first through twenty-sixth aspects, process 1000 includes transmitting a request for the UE to report PHR, wherein the request is associated with an uplink transmission grant.

In a twenty-eighth aspect, alone or in combination with one or more of the first through twenty-seventh aspects, process 1000 includes transmitting a configuration that overrides a previous configuration of the UE and enables the one or more PHR parameters that are flexible for the UE.

In a twenty-ninth aspect, alone or in combination with one or more of the first through twenty-eighth aspects, process 1000 includes transmitting an indication for the UE to toggle an activation state of the one or more PHR parameters that are flexible for the UE.

In a thirtieth aspect, alone or in combination with one or more of the first through twenty-ninth aspects, the one or more PHR parameters that are flexible for the UE are associated with an AI/ML model at the UE.

In a thirty-first aspect, alone or in combination with one or more of the first through thirtieth aspects, process 1000 includes transmitting information indicating the AI/ML model.

In a thirty-second aspect, alone or in combination with one or more of the first through thirty-first aspects, the AI/ML model is trained using at least one of a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

In a thirty-third aspect, alone or in combination with one or more of the first through thirty-second aspects, process 1000 includes receiving an indication of at least one of a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node, a message indicating that one or more PHR parameters are flexible for the UE. The communication manager 1106 may select a value for the one or more PHR parameters in accordance with the message. The transmission component 1104 may transmit a PHR in accordance with the one or more PHR parameters.

The reception component 1102 may receive a request to report PHR, wherein the request is associated with an uplink transmission grant.

The reception component 1102 may receive a configuration that overrides a previous configuration of the UE and enables the one or more PHR parameters that are flexible for the UE.

The reception component 1102 may receive an indication to toggle an activation state of the one or more PHR parameters that are flexible for the UE.

The reception component 1102 may receive information indicating the AI/ML model.

The communication manager 1106 may train the AI/ML model using at least one of a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

The transmission component 1104 may transmit an indication of at least one of a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, a message indicating that one or more PHR parameters are flexible for the UE. The reception component 1202 may receive a PHR in accordance with the one or more PHR parameters. The reception component 1202 and/or the transmission component 1204 may communicate in accordance with the PHR.

The transmission component 1204 may transmit a request for the UE to report PHR, wherein the request is associated with an uplink transmission grant.

The transmission component 1204 may transmit a configuration that overrides a previous configuration of the UE and enables the one or more PHR parameters that are flexible for the UE.

The transmission component 1204 may transmit an indication for the UE to toggle an activation state of the one or more PHR parameters that are flexible for the UE.

The transmission component 1204 may transmit information indicating the AI/ML model.

The reception component 1202 may receive an indication of at least one of a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some aspects of the present disclosure:

Aspect 1: A method of wireless communication performed by a UE, comprising: receiving, from a network node, a message indicating that one or more PHR parameters are flexible for the UE; selecting a value for the one or more PHR parameters in accordance with the message; and transmitting a PHR in accordance with the one or more PHR parameters.

Aspect 2: The method of Aspect 1, wherein the one or more PHR parameters comprise one or more of a periodic timer, a prohibit timer, a pathloss-based triggering parameter, or a power threshold.

Aspect 3: The method of any of Aspects 1-2, wherein the message indicates a range of values for the one or more PHR parameters, and wherein the value is included in the range of values.

Aspect 4: The method of any of Aspects 1-3, wherein the one or more PHR parameters comprise a reporting mode parameter for reporting PHR for a primary serving cell associated with the UE or for multiple serving cells associated with the UE.

Aspect 5: The method of Aspect 4, further comprising: selecting between a single entry PHR type and a multiple entry PHR type.

Aspect 6: The method of any of Aspects 1-5, wherein the one or more PHR parameters comprise a PHR reporting mode.

Aspect 7: The method of Aspect 6, further comprising: selecting the PHR reporting mode from a plurality of PHR reporting modes according to a traffic pattern associated with the UE.

Aspect 8: The method of any of Aspects 1-7, wherein the one or more PHR parameters comprise a PHR reporting trigger parameter associated with a power condition at the UE.

Aspect 9: The method of Aspect 8, further comprising: selecting the PHR reporting trigger parameter from a set of PHR reporting triggers, in association with a power mode of operation condition, according to the power condition at the UE.

Aspect 10: The method of any of Aspects 1-9, wherein the one or more PHR parameters comprise a PHR reporting trigger parameter associated with one or more of a dual connectivity mode of the UE or a dual band carrier aggregation mode of the UE.

Aspect 11: The method of Aspect 10, further comprising: selecting the PHR reporting trigger parameter from a set of PHR reporting triggers according to the dual connectivity mode of the UE.

Aspect 12: The method of any of Aspects 1-11, wherein the one or more PHR parameters comprise a PHR reporting trigger parameter associated with uplink traffic at the UE.

Aspect 13: The method of Aspect 12, further comprising: selecting the PHR reporting trigger parameter from a set of PHR reporting triggers according to the uplink traffic at the UE and a service requirement of the UE.

Aspect 14: The method of any of Aspects 1-13, wherein the message indicates a range of values for at least one of a periodic timer, a prohibit timer, a pathloss-based triggering parameter, or a power threshold, and wherein selecting the value for the one or more PHR parameters includes: selecting a value, from the range of values, for the at least one of the periodic timer, the prohibit timer, the pathloss-based triggering parameter, or the power threshold.

Aspect 15: The method of any of Aspects 1-14, further comprising: selecting a triggering condition for the PHR.

Aspect 16: The method of any of Aspects 1-15, further comprising: toggling an on or off state of the one or more PHR parameters.

Aspect 17: The method of any of Aspects 1-16, wherein selecting the value for the one or more PHR parameters is associated with a quantity of occurrences of a PHR control element transmission.

Aspect 18: The method of any of Aspects 1-17, wherein selecting the value for the one or more PHR parameters is associated with a pathloss value for a PHR transmission.

Aspect 19: The method of any of Aspects 1-18, wherein selecting the value for the one or more PHR parameters is associated with a quantity of occurrences of delayed PHR transmission due to a PHR timer.

Aspect 20: The method of any of Aspects 1-19, wherein selecting the value for the one or more PHR parameters is associated with a quantity of occurrences of a PHR transmission associated with secondary cell activation or a bandwidth part activation.

Aspect 21: The method of any of Aspects 1-20, wherein selecting the value for the one or more PHR parameters is associated with a quantity of occurrences of a PHR transmission associated with exceeding a duty cycle.

Aspect 22: The method of any of Aspects 1-21, wherein selecting the value for the one or more PHR parameters is associated with a variation in timer-based reporting.

Aspect 23: The method of any of Aspects 1-22, wherein selecting the value for the one or more PHR parameters is associated with a quantity of occurrences of power condition-based PHR triggering associated with one or more frequency band specifications.

Aspect 24: The method of any of Aspects 1-23, wherein selecting the value for the one or more PHR parameters is associated with a quantity of occurrences of a power condition being satisfied for an activated serving cell associated with the UE.

Aspect 25: The method of any of Aspects 1-24, wherein selecting the value for the one or more PHR parameters is associated with a distribution of occurrences of a first report type and a second report type.

Aspect 26: The method of any of Aspects 1-25, wherein selecting the value for the one or more PHR parameters is associated with a distribution of one or more of: uplink traffic at the UE, or a quality of service parameter at the UE.

Aspect 27: The method of any of Aspects 1-26, wherein selecting the value for the one or more PHR parameters is associated with a statistic associated with buffering at the UE.

Aspect 28: The method of any of Aspects 1-27, further comprising: receiving a request to report PHR, wherein the request is associated with an uplink transmission grant.

Aspect 29: The method of any of Aspects 1-28, further comprising: receiving a configuration that overrides a previous configuration of the UE and enables the one or more PHR parameters that are flexible for the UE.

Aspect 30: The method of any of Aspects 1-29, further comprising: receiving an indication to toggle an activation state of the one or more PHR parameters that are flexible for the UE.

Aspect 31: The method of any of Aspects 1-30, wherein the value for the one or more PHR parameters is selected using an artificial intelligence or machine learning (AI/ML) model.

Aspect 32: The method of Aspect 31, further comprising: receiving information indicating the AI/ML model.

Aspect 33: The method of any of Aspects 31-32, further comprising training the AI/ML model using at least one of: a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

Aspect 34: The method of any of Aspects 31-33, further comprising transmitting an indication of at least one of: a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

Aspect 35: A method of wireless communication performed by a network node, comprising: transmitting, to a UE, a message indicating that one or more PHR parameters are flexible for the UE; receiving a PHR in accordance with the one or more PHR parameters; and communicating in accordance with the PHR.

Aspect 36: The method of Aspect 35, wherein the one or more PHR parameters comprise one or more of a periodic timer, a prohibit timer, a pathloss-based triggering parameter, or a power threshold.

Aspect 37: The method of any of Aspects 35-36, wherein the message indicates a range of values for the one or more PHR parameters, and wherein the value is included in the range of values.

Aspect 38: The method of any of Aspects 35-37, wherein the one or more PHR parameters comprise a reporting mode parameter for reporting PHR for a primary serving cell associated with the UE or for multiple serving cells associated with the UE.

Aspect 39: The method of Aspect 38, wherein the one or more PHR parameters that are flexible for the UE include at least one of a single entry PHR type or a multiple entry PHR type.

Aspect 40: The method of any of Aspects 35-39, wherein the one or more PHR parameters comprise a PHR type.

Aspect 41: The method of Aspect 40, wherein the one or more PHR parameters that are flexible for the UE include a plurality of PHR reporting modes each associated with a respective traffic pattern at the UE.

Aspect 42: The method of any of Aspects 35-41, wherein the one or more PHR parameters comprise a PHR reporting trigger parameter associated with a power condition at the UE.

Aspect 43: The method of Aspect 42, wherein the one or more PHR parameters that are flexible for the UE include a set of PHR reporting triggers, in association with a power mode of operation condition, according to the power condition at the UE.

Aspect 44: The method of any of Aspects 35-43, wherein the one or more PHR parameters comprise a PHR reporting trigger parameter associated with one or more of a dual connectivity mode of the UE or a dual band carrier aggregation mode of the UE.

Aspect 45: The method of Aspect 44, wherein the UE may select the PHR reporting trigger parameter from a set of PHR reporting triggers according to the dual connectivity mode of the UE.

Aspect 46: The method of any of Aspects 35-45, wherein the one or more PHR parameters comprise a PHR reporting trigger parameter associated with uplink traffic at the UE.

Aspect 47: The method of Aspect 46, wherein the message indicates a set of selectable PHR reporting triggers associated with the uplink traffic at the UE and a service requirement of the UE, and the set of selectable PHR reporting triggers includes the PHR reporting trigger parameter.

Aspect 48: The method of any of Aspects 35-47, wherein the message indicates a range of values for at least one of a periodic timer, a prohibit timer, a pathloss-based triggering parameter, or a power threshold.

Aspect 49: The method of any of Aspects 35-48, wherein the message indicates a selectable triggering condition for the PHR.

Aspect 50: The method of any of Aspects 35-49, wherein the message indicates a togglable on or off state of the one or more PHR parameters.

Aspect 51: The method of any of Aspects 35-50, wherein the one or more PHR parameters that are flexible for the UE are associated with a quantity of occurrences of a PHR control element transmission.

Aspect 52: The method of any of Aspects 35-51, wherein the one or more PHR parameters that are flexible for the UE are associated with a pathloss value for a PHR transmission.

Aspect 53: The method of any of Aspects 35-52, wherein the one or more PHR parameters that are flexible for the UE are associated with a quantity of occurrences of delayed PHR transmission due to a PHR timer.

Aspect 54: The method of any of Aspects 35-53, wherein the one or more PHR parameters that are flexible for the UE are associated with a quantity of occurrences of a PHR transmission associated with secondary cell activation or a bandwidth part activation.

Aspect 55: The method of any of Aspects 35-54, wherein the one or more PHR parameters that are flexible for the UE are associated with a quantity of occurrences of a PHR transmission associated with exceeding a duty cycle.

Aspect 56: The method of any of Aspects 35-55, wherein the one or more PHR parameters that are flexible for the UE are associated with a variation in timer-based reporting.

Aspect 57: The method of any of Aspects 35-56, wherein the one or more PHR parameters that are flexible for the UE are associated with a quantity of occurrences of power condition-based PHR triggering associated with one or more frequency band specifications.

Aspect 58: The method of any of Aspects 35-57, wherein the one or more PHR parameters that are flexible for the UE are associated with a quantity of occurrences of a power condition being satisfied for an activated serving cell associated with the UE.

Aspect 59: The method of any of Aspects 35-58, wherein the one or more PHR parameters that are flexible for the UE are associated with a distribution of occurrences of a first report type and a second report type.

Aspect 60: The method of any of Aspects 35-59, wherein the one or more PHR parameters that are flexible for the UE are associated with a distribution of one or more of: uplink traffic at the UE, or a quality of service parameter at the UE.

Aspect 61: The method of any of Aspects 35-60, wherein the one or more PHR parameters that are flexible for the UE are associated with a statistic associated with buffering at the UE.

Aspect 62: The method of any of Aspects 35-61, further comprising: transmitting a request for the UE to report PHR, wherein the request is associated with an uplink transmission grant.

Aspect 63: The method of any of Aspects 35-62, further comprising: transmitting a configuration that overrides a previous configuration of the UE and enables the one or more PHR parameters that are flexible for the UE.

Aspect 64: The method of any of Aspects 35-63, further comprising: transmitting an indication for the UE to toggle an activation state of the one or more PHR parameters that are flexible for the UE.

Aspect 65: The method of any of Aspects 35-64, wherein the one or more PHR parameters that are flexible for the UE are associated with an artificial intelligence or machine learning (AI/ML) model at the UE.

Aspect 66: The method of Aspect 65, further comprising: transmitting information indicating the AI/ML model.

Aspect 67: The method of any of Aspects 65-66, wherein the AI/ML model is trained using at least one of: a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

Aspect 68: The method of any of Aspects 65-67, further comprising: receiving an indication of at least one of: a quantity of occurrences of a PHR control element transmission, a pathloss value for PHR transmission, a quantity of occurrences of delayed PHR transmission due to a PHR timer, a quantity of occurrences of a PHR transmission associated with secondary cell activation or a bandwidth part activation, a quantity of occurrences of a PHR transmission associated with exceeding a duty cycle, a variation in timer-based reporting, a quantity of occurrences of power condition-based PHR triggering associated with one or more frequency band specifications, a quantity of occurrences of a power condition being satisfied for an activated serving cell associated with the UE, a distribution of occurrences of a first report type and a second report type, a distribution of uplink traffic at the UE associated with a quality of service parameter at the UE, or a statistic associated with buffering at the UE.

Aspect 69: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-68.

Aspect 70: An apparatus for wireless communication at a device, the apparatus comprising one or more memories and one or more processors coupled to the one or more memories, the one or more processors configured to cause the device to perform the method of one or more of Aspects 1-68.

Aspect 71: An apparatus for wireless communication, the apparatus comprising at least one means for performing the method of one or more of Aspects 1-68.

Aspect 72: A non-transitory computer-readable medium storing code for wireless communication, the code comprising instructions executable by one or more processors to perform the method of one or more of Aspects 1-68.

Aspect 73: A non-transitory computer-readable medium storing a set of instructions for wireless communication, the set of instructions comprising one or more instructions that, when executed by one or more processors of a device, cause the device to perform the method of one or more of Aspects 1-68.

Aspect 74: A device for wireless communication, the device comprising a processing system that includes one or more processors and one or more memories coupled with the one or more processors, the processing system configured to cause the device to perform the method of one or more of Aspects 1-68.

Aspect 75: An apparatus for wireless communication at a device, the apparatus comprising one or more memories and one or more processors coupled to the one or more memories, the one or more processors individually or collectively configured to cause the device to perform the method of one or more of Aspects 1-68.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive, from a network node, a message indicating that one or more power headroom report (PHR) parameters are flexible for the UE;
select a value for the one or more PHR parameters in accordance with the message; and
transmit a PHR in accordance with the one or more PHR parameters.

2. The apparatus of claim 1, wherein the one or more PHR parameters comprise one or more of a periodic timer, a prohibit timer, a pathloss-based triggering parameter, or a power threshold.

3. The apparatus of claim 1, wherein the message indicates a range of values for the one or more PHR parameters, and wherein the value is included in the range of values.

4. The apparatus of claim 1, wherein the one or more PHR parameters comprise a reporting mode parameter for reporting PHR for a primary serving cell associated with the UE or for multiple serving cells associated with the UE.

5. The apparatus of claim 4, wherein the one or more processors are configured to cause the UE to:
select between a single entry PHR type and a multiple entry PHR type.

6. The apparatus of claim 1, wherein the one or more PHR parameters comprise a PHR reporting mode.

7. The apparatus of claim 6, wherein the one or more processors are configured to cause the UE to:
select the PHR reporting mode from a plurality of PHR reporting modes according to a traffic pattern associated with the UE.

8. The apparatus of claim 1, wherein the one or more PHR parameters comprise a PHR reporting trigger parameter associated with a power condition at the UE.

9. The apparatus of claim 8, wherein the one or more processors are configured to cause the UE to:
select the PHR reporting trigger parameter from a set of PHR reporting triggers, in association with a power mode of operation condition, according to the power condition at the UE.

10. The apparatus of claim 1, wherein the one or more PHR parameters comprise a PHR reporting trigger parameter associated with one or more of a dual connectivity mode of the UE or a dual band carrier aggregation mode of the UE.

11. The apparatus of claim 10, wherein the one or more processors are configured to cause the UE to:
select the PHR reporting trigger parameter from a set of PHR reporting triggers according to the dual connectivity mode of the UE.

12. The apparatus of claim 1, wherein the one or more PHR parameters comprise a PHR reporting trigger parameter associated with uplink traffic at the UE.

13. The apparatus of claim 12, wherein the one or more processors are configured to cause the UE to:
select the PHR reporting trigger parameter from a set of PHR reporting triggers according to the uplink traffic at the UE and a service requirement of the UE.

14. The apparatus of claim 1, wherein the message indicates a range of values for at least one of a periodic timer, a prohibit timer, a pathloss-based triggering parameter, or a power threshold, and wherein the one or more processors, to select the value for the one or more PHR parameters, are configured to:
select the value, from the range of values, for the at least one of the periodic timer, the prohibit timer, the pathloss-based triggering parameter, or the power threshold.

15. The apparatus of claim 1, wherein the one or more processors are configured to cause the UE to:
select a triggering condition for the PHR.

16. The apparatus of claim 1, wherein the one or more processors are configured to cause the UE to:
toggle an on or off state of the one or more PHR parameters.

17. The apparatus of claim 1, wherein the one or more processors are further configured to cause the UE to:
receive a request to report PHR, wherein the request is associated with an uplink transmission grant.

18. The apparatus of claim 1, wherein the one or more processors are further configured to cause the UE to:
receive a configuration that overrides a previous configuration of the UE and enables the one or more PHR parameters that are flexible for the UE.

19. The apparatus of claim 1, wherein the one or more processors are further configured to cause the UE to:
receive an indication to toggle an activation state of the one or more PHR parameters that are flexible for the UE.

20. An apparatus for wireless communication at a network node, comprising:
one or more memories; and
one or more processors, coupled to the one or more memories, configured to cause the network node to:
transmit, to a user equipment (UE), a message indicating that one or more power headroom report (PHR) parameters are flexible for the UE;
receive a PHR in accordance with the one or more PHR parameters; and
communicate in accordance with the PHR.

21. The apparatus of claim 20, wherein the one or more PHR parameters that are flexible for the UE are associated with an artificial intelligence or machine learning (AI/ML) model at the UE.

22. The apparatus of claim 21, wherein the one or more processors are further configured to cause the network node to:
transmit information indicating the AI/ML model.

23. The apparatus of claim 21, wherein the AI/ML model is trained using at least one of:
a quantity of occurrences of a PHR control element transmission,
a pathloss value for PHR transmission,
a quantity of occurrences of delayed PHR transmission due to a PHR timer,
a quantity of occurrences of a PHR transmission associated with secondary cell activation or a bandwidth part activation,
a quantity of occurrences of a PHR transmission associated with exceeding a duty cycle,
a variation in timer-based reporting,
a quantity of occurrences of power condition-based PHR triggering associated with one or more frequency band specifications,
a quantity of occurrences of a power condition being satisfied for an activated serving cell associated with the UE,
a distribution of occurrences of a first report type and a second report type,
a distribution of uplink traffic at the UE associated with a quality of service parameter at the UE, or
a statistic associated with buffering at the UE.

24. The apparatus of claim 21, wherein the one or more processors are further configured to cause the network node to:
receive an indication of at least one of:
a quantity of occurrences of a PHR control element transmission,
a pathloss value for PHR transmission,
a quantity of occurrences of delayed PHR transmission due to a PHR timer,
a quantity of occurrences of a PHR transmission associated with secondary cell activation or a bandwidth part activation,
a quantity of occurrences of a PHR transmission associated with exceeding a duty cycle,
a variation in timer-based reporting,
a quantity of occurrences of power condition-based PHR triggering associated with one or more frequency band specifications,
a quantity of occurrences of a power condition being satisfied for an activated serving cell associated with the UE,
a distribution of occurrences of a first report type and a second report type,
a distribution of uplink traffic at the UE associated with a quality of service parameter at the UE, or
a statistic associated with buffering at the UE.

25. A method of wireless communication performed by a user equipment (UE), comprising:
receiving, from a network node, a message indicating that one or more power headroom report (PHR) parameters are flexible for the UE;
selecting a value for the one or more PHR parameters in accordance with the message; and
transmitting a PHR in accordance with the one or more PHR parameters.

26. The method of claim 25, wherein the value for the one or more PHR parameters is selected using an artificial intelligence or machine learning (AI/ML) model.

27. The method of claim 26, further comprising:
receiving information indicating the AI/ML model.

28. The method of claim 26, further comprising training the AI/ML model using at least one of:
a quantity of occurrences of a PHR control element transmission,
a pathloss value for PHR transmission,
a quantity of occurrences of delayed PHR transmission due to a PHR timer,
a quantity of occurrences of a PHR transmission associated with secondary cell activation or a bandwidth part activation,
a quantity of occurrences of a PHR transmission associated with exceeding a duty cycle,
a variation in timer-based reporting,
a quantity of occurrences of power condition-based PHR report triggering associated with one or more frequency band specifications,
a quantity of occurrences of a power condition being satisfied for an activated serving cell associated with the UE,
a distribution of occurrences of a first report type and a second report type,
a distribution of uplink traffic at the UE associated with a quality of service parameter at the UE, or
a statistic associated with buffering at the UE.

29. The method of claim 26, further comprising transmitting an indication of at least one of:
a quantity of occurrences of a PHR control element transmission,
a pathloss value for PHR transmission,
a quantity of occurrences of delayed PHR transmission due to a PHR timer,
a quantity of occurrences of a PHR transmission associated with secondary cell activation or a bandwidth part activation,
a quantity of occurrences of a PHR transmission associated with exceeding a duty cycle,
a variation in timer-based reporting,
a quantity of occurrences of power condition-based PHR report triggering associated with one or more frequency band specifications,
a quantity of occurrences of a power condition being satisfied for an activated serving cell associated with the UE,
a distribution of occurrences of a first report type and a second report type,
a distribution of uplink traffic at the UE associated with a quality of service parameter at the UE, or
a statistic associated with buffering at the UE.

30. A method of wireless communication performed by a network node, comprising:
transmitting, to a user equipment (UE), a message indicating that one or more power headroom report (PHR) parameters are flexible for the UE;
receiving a PHR in accordance with the one or more PHR parameters; and
communicating in accordance with the PHR.
